(19) United States
(12) Patent Application Publication
(10) Pub. No.: US 2023/0416436 A1
(43) Pub. Date: Dec. 28, 2023

(54) STEREOBLOCK DIENE COPOLYMERS AND PREPARATION PROCESS THEREOF

(71) Applicant: KM Technologies GmbH, Rovereto (CH)

(72) Inventors: Adriano Malacchini, Dubai (AE); Giovanni Ricci, Parma (IT); Giuseppe Leone, Milano (IT)

(21) Appl. No.: 18/039,172

(22) PCT Filed: Nov. 25, 2021
(86) PCT No.: PCT/EP2021/082931

§ 371 Date: May 26, 2023

(30) Foreign Application Priority Data
Nov. 27, 2020 (IT) 102020000028823

(51) Int. Cl. C08F 236/08; C08F 236/06; C08F 297/08; C08F 4/12; C08F 236/04

(52) U.S. Cl. CPC C08F 236/08; C08F 236/06; C08F 236/045; C08F 4/12; C08F 297/086

(57) ABSTRACT

The invention relates to isoprene and butadiene and/or pentadiene stereoblock copolymers in which the different stereoregular blocks, joined to each other by means of a single junction point, have different structures and thermal properties. The invention also relates to a process for the preparation of the aforesaid copolymers which comprises the formation of stereoblocks in successive steps but in the presence of a single catalytic system obtained from cobalt dichloride, a phosphine and an organic compound of aluminum.

The present invention relates to stereoblock diene copolymers in which the different stereoregular blocks, joined to each other by means of a single junction point, have different structures and thermal properties.

More in particular, the present invention relates to copolymers of isoprene and butadiene and/or pentadiene.

The present invention also relates to a process for the preparation of the aforesaid copolymers. It is known that the stereospecific polymerization of conjugated dienes is an extremely important process in the chemical industry in order to obtain products that are among the most widely used rubbers.

It is also known that among the various polymers that can be obtained from the stereospecific polymerization of 1,3-butadiene (i.e., 1,4-cis; 1,4-trans; syndiotactic 1,2; isotactic 1,2; atactic 1,2; mixed 1,4-cis/1,2 structure having a variable content of 1,2 units), of isoprene (i.e., 1,4-cis; 1,4-trans; syndiotactic and isotactic 3,4; alternating cis-1,4/3,4 structure), and of pentadiene (i.e., iso- and syndiotactic 1,4-cis; isotactic 1,4-trans; syndiotactic 1,2, cis and trans) [in Porri L. et al., “Comprehensive Polymer Science” (1989), Eastmond G. C. et al. Eds., Pergamon Press, Oxford, UK, Vol. 4, Part II, pages 53-108] only 1,4-cis polybutadiene, syndiotactic 1,2 polybutadiene and the cis-1,4 polyisoprene are industrially produced and marketed. Further details relating to said polymers can, for example, be found in: Takeuchi Y. et al., “New Industrial Polymers”, “American Chemical Society Symposium Series” (1974), Vol. 4, pages 15-25; Halasa A. F. et al., “Kirk-Othmer Encyclopedia of Chemical Technology” (1989), 4^{th} Ed., Kroschwitz J. I. Ed., John Wiley and Sons, New York, Vol. 8, pages 1031-1045; Tate D. et al., “Encyclopedia of Polymer Science and Engineering (1989), 2^{nd} Ed., Mark H. F. Ed., John Wiley and Sons, New York, Vol. 2, pages 537-590; Kerns M. et al., “Butadiene Polymers”, in “Encyclopedia of Polymer Science and Technology” (2003), Mark H. F. Ed., Wiley, Vol. 5, pages 317-356.

All the isoprene, pentadiene and butadiene polymers cited above can be prepared by means of different catalytic systems based on transition metals (e.g., Ti, V, Cr, Fe, Co, Ni) and lanthanides (e.g., La, Pr, Nd) [in Porri L. et al., “Comprehensive Polymer Science” (1989), Eastmond G. C. et al. Eds., Pergamon Press, Oxford, UK, Vol. 4, Part II, pages 53-108; Thiele S. K. H. et al., “Macromolecular Science. Part C: Polymer Reviews” (2003), C43, pages 581-628; Osakada, K. et al., “Advanced Polymer Science” (2004), Vol. 171, pages 137-194]. In fact, by suitably varying the catalytic system, type of monomer and polymerization conditions, it is possible to prepare stereoregular polymers of different structure (cis-1,4; trans-1,4; iso and syndiotactic 1,2 structure; iso and syndiotactic 3,4 structure; mixed cis-1,4/1,2 structure).

Catalytic systems based on cobalt are without doubt more versatile than those used for polymerization of conjugated di-olefins as, for example, by suitably choosing the catalytic formulation, they are able to provide from butadiene all the possible isomers of polybutadiene [Ricci G. et al. Polymer Commun (1991) 32, 514-517; Ricci G. et al., “Advances in Organometallic Chemistry Research” (2007), Yamamoto K. Ed., Nova Science Publisher, Inc., USA, pages 1-36; Ricci G. et al., “Coordination Chemistry Reviews” (2010), Vol. 254, pages 661-676; Ricci G. et al., “Cobalt: Characteristics, Compounds, and Applications” (2011), Lucas J. Vidmar Ed., Nova Science Publisher, Inc., USA, pages 39-81].

In particular, the CoCl₂/MAO system is capable of providing linear polybutadiene with a high content in cis-1,4 units (˜97%) (Ricci G. et al., “Coordination Chemistry Reviews” (2010), Vol. 254, pages 661-676), while the complexes of CoCl₂ with mono- and bi-dentate, aliphatic, cycloaliphatic or aromatic phosphines, in combination with methylaluminoxane, enabled the preparation of polybutadiene with a controlled microstructure, ranging from polybutadiene with a very high cis-1,4 content (>97%) to highly syndiotactic 1,2 polybutadiene, passing through all the intermediate mixed cis-14/1,2 compositions, simply by varying the type of phosphine coordinated with the cobalt [see patents IT 1.349.141, IT 1.349.142, IT 1.349.143, international patent applications WO 2003/018649; U.S. Pat. Nos. 5,879,805, 4,324,939, 3,966,697, 4,285,833, 3,498,963, 3,522,332, 4,182,813, 5,548,045, 7,009,013; or the articles Shiono T. et al., in “Macromolecular Chemistry and Physics” (2002), Vol. 203, pages 1171-1177, “Applied Catalysis A: General” (2003), Vol. 238, pages 193-199, “Macromolecular Chemistry and Physics” (2003), Vol. 204, pages 2017-2022, “Macromolecules” (2009), Vol. 42, pages 7642-7643].

More specifically, using the catalytic systems CoCl₂(PRPh₂)₂/MAO (R=Me, Et, ⁿPr, ⁱPr, ^{t}Bu, Cy), polybutadienes with an essentially 1,2 structure (in a range from 70% to 90%), having a variable content in 1,2 units in relation to the type of complex and of the polymerization conditions were obtained [G. Ricci, A. Forni, A. Boglia, T. Motta “Synthesis, structure, and butadiene polymerization behavior of alkylphosphine cobalt (II) complexes” J. Mol. Catal. A: Chem. 2005, 226, 235-241; G. Ricci, A. Forni, A. Boglia, T. Motta, G. Zannoni, M. Canetti, F. Bertini “Synthesis and X-Ray structure of CoCl₂(PⁱPrPh₂)₂. A new highly active and stereospecific catalyst for 1,2 polymerization of conjugated dienes when used associated with MAO” Macromolecules 2005, 38, 1064-1070; G. Ricci, A. Forni, A. Boglia, A. Sommazzi, F. Masi “Synthesis, structure and butadiene polymerization behavior of CoCl₂(PRₓPh₃₋ₓ)₂ (R=methyl, ethyl, propyl, allyl, isopropyl, cyclohexyl; x=1,2). Influence of the phosphorous ligand on polymerization stereoselectivity” J. Organomet. Chem. 2005, 690, 1845-1854; G. Ricci, A. C. Boccia, G. Leone, A. Forni. “Novel Allyl Cobalt Phosphine Complexes: Synthesis, Characterization, and Behavior in the Polymerization of Allene and 1,3-Dienes” Catalysts 2017, 7, 381].

It has also been observed that the tacticity of the polybutadienes obtained depends greatly on the type of complex, i.e., the type of phosphine bound to the cobalt atom, and that the syndiotacticity index, expressed as content (i.e., percentage) of syndiotactic triads [(rr) %], determined by means of analysis of the ¹³C-NMR spectra, increases as the steric requirement of the alkyl group bound to the phosphorus atom increases.

The 1,2 polybutadienes obtained with the cobalt systems with less sterically hindered phosphines (e.g., PMePh₂; PEtPh₂; PⁿPrPh₂ wherein P=phosphorus, Me=methyl, Et=ethyl, Ph=phenyl, ⁿPr=n-propyl) have low crystallinity and a content of syndiotactic triads [(rr) %] between 20% and 50%, while the polybutadienes obtained with catalytic systems using phosphines with higher steric hindrance (e.g., PⁱPrPh₂, P^{t}BuPh₂, PCyPh₂ wherein P=phosphorus, ⁱPr=iso-propyl, Cy=cyclohexyl, ^{t}Bu=tert-butyl, Ph=phenyl,) proved to be crystalline, with a melting point (Tₘ) between 80° C. and 140° C. and with a content of syndiotactic triads [(rr) %] between 60% and 80%, depending on the polymerization conditions. These CoCl₂(PRPh)₂-MAO systems, wherein R=alkyl, cycloalkyl or phenyl group, are extremely active also in the polymerization of isoprene, providing a particular polymer, having a perfectly alternating cis-1,4/3,4 structure [G. Ricci, G. Leone, A. Boglia, A. C. Boccia, L. Zetta “Cis-1,4-alt-3,4 Polyisoprene: Synthesis and Characterization” Macromolecules 2009, 42, 9263-9267], and in the polymerization of pentadiene, providing a polymer with a syndiotactic 1,2 structure [G. Ricci, A. Forni, A. Boglia, T. Motta, G. Zannoni, M. Canetti, F. Bertini “Synthesis and X-Ray structure of CoCl₂(PⁱPrPh₂)₂. A new highly active and stereospecific catalyst for 1,2 polymerization of conjugated dienes when used associated with MAO” Macromolecules 2005, 38, 1064-1070; G. Ricci, T. Motta, A. Boglia, E. Alberti, L. Zetta, F. Bertini, P. Arosio, A. Famulari, S. V. Meille. “Synthesis, characterization and crystalline structure of syndiotactic 1,2 polypentadiene: the trans polymer.” Macromolecules 2005, 38, 8345-8352].

The influence of the type of phosphine bound to the cobalt atom on the polymerization selectivity can be attributed to the fact that, as is well known, the steric and electronic properties of phosphines depend greatly on the type of substituents on the phosphorus atom, as described, for example, in: Dierkes P. et al., “Journal of Chemical Society, Dalton Transactions” (1999), pages 1519-1530; van Leeuwen P. et al., “Chemical Reviews” (2000), Vol. 100, pages 2741-2769; Freixa Z. et al., “Dalton Transactions” (2003), pages 1890-1901; Tolman C., “Chemical Reviews” (1977), Vol. 77, p. 313-348.

We have now found that it is not necessary, in the preparation of the catalytic system, to use preformed phosphine complexes of cobalt, but the same results, from the viewpoint of both activity and selectivity, can be obtained using as catalytic component (also called pre-catalyst) the product of the reaction between CoCl₂ and phosphine in CH₂Cl₂ as solvent. We have also found that these catalytic systems, besides having high activity and selectivity, are also “living”, (evidence of this characteristic was also reported by Shiono T. et al., Macromolecules” (2009), Vol. 42, pages 7642-7643) i.e., they provide living polymers, as indicated by the extremely low molecular weight dispersion (1.5-2.5).

This characteristic, associated with the different selectivity shown in the polymerization of butadiene, isoprene and pentadiene (i.e., crystalline syndiotactic 1,2 polybutadiene, polyisoprene with an amorphous alternating cis-1,4/3,4 structure, crystalline syndiotactic 1,2 polypentadiene), provided the opportunity for the synthesis of stereoblock copolymers and terpolymers of the following types:
butadiene/isoprene stereoblock copolymer consisting of a crystalline syndiotactic 1,2 polybutadiene block and of a polyisoprene block with an amorphous perfectly alternating cis-1,4/3,4 structure, joined to each other by means of a single junction point;
pentadiene/isoprene stereoblock copolymer consisting of a crystalline syndiotactic 1,2 polypentadiene block and of a polyisoprene block with an amorphous perfectly alternating cis-1,4/3,4 structure, joined to each other by means of a single junction point;
pentadiene/isoprene/butadiene stereoblock terpolymer, consisting of a crystalline syndiotactic 1,2 polypentadiene block, of a polyisoprene block with an amorphous perfectly alternating cis-1,4/3,4 structure, and of a crystalline syndiotactic 1,2 polybutadiene block, joined to each other by means of a single junction point;
butadiene/isoprene/butadiene stereoblock terpolymer, consisting of a crystalline syndiotactic 1,2 polybutadiene block, of a polyisoprene block with an amorphous perfectly alternating cis-1,4/3,4 structure, and moreover of a crystalline syndiotactic 1,2 polybutadiene block, joined to each other by means of a single junction point.

Symmetrical or asymmetrical, diblock or triblock polymers based on butadiene are known, although these differ greatly from the stereoblock copolymers and terpolymers of the present invention from the point of view of composition and microstructure, and also of production method. In fact, the diblock or triblock polymers known in the art are essentially obtained by post-modification reactions (e.g., grafting) of various homopolymers, or by anionic polymerization, using lithium alkyls as reagents, or by emulsion polymerization, using radical initiators.

Said diblock or triblock polymers are often formed by the joining of polybutadiene blocks with different structures, prevalently a 1,4-trans structure, as this is the predominant structure in the anionic or radicalic polymerization of butadiene, with polyisoprene, styrene or styrene-butadiene blocks. In particular, it should be pointed out that in a polybutadiene block with a 1,4-trans structure, the double bonds are along the main chain, while in the polybutadiene block with a syndiotactic 1,2 structure of the stereoregular polybutadiene diblock of the present invention, the double bonds are outside the main chain.

Further details relating to the aforesaid diblock or triblock polymers can be found, for example, in: Szwark M. et al., “Journal of the American Chemical Society” (1956), Vol. 78, 2656; Hsieh H. L. et al., “Anionic polymerization: principles and practical applications” (1996), 1^{st} Ed., Marcel Dekker, New York; Lovell P. A. et al., “Emulsion polymerization and emulsion polymers” (1997), Wiley New York; Xie H. et al., “Journal of Macromelecular Science: Part A—Chemistry” (1985), Vol. 22 (10), pages 1333-1346; Wang Y. et al., “Journal of Applied Polymer Science” (2003), Vol. 88, pages 1049-1054.

It is also known that although anionic or radicalic polymerizations allow the composition of the diblock or triblock polymers obtained, i.e., the percentage of comonomers present, to be controlled, they are not able to exert an adequate control on the type of stereoregularity of the blocks (e.g., in the case of butadiene, the 1,4-cis vs 1,2 vs. 1,4-trans selectivity) contrary to what occurs in stereospecific polymerization.

For example, Zhang X. et al., in “Polymer” (2009), Vol. 50, p. 5427-5433, describe the synthesis and characterization of triblock polybutadienes containing a crystallizable high 1,4-trans polybutadiene block. Said synthesis was carried out by means of sequential anionic polymerization of butadiene, in the presence of barium salt of di(ethyleneglycol)ethylether/tri-iso-butyl-aluminum/dilithium (BaDEGEE/TIBA/DLi), as initiator. The triblock polybutadienes thus obtained were analyzed and showed the following composition: high 1,4-trans-b-low 1,4-cis-b-high 1,4-trans (HTPB-b-LCPB-b-HTPBs). Said triblock polybutadienes consisted of an elastic block with a low content of 1,4-cis units chemically bound to blocks with a high content of crystallizable 1,4-trans units. The ratio between the (HTPB:LCPB:HTPBs) blocks was the following: 25:50:25. The HTPB-b-LCPB-b-HTPBs triblock polybutadienes obtained consisted of the LCPB block with a 1,4-trans content equal to 52.5% and of the HTPB blocks with a 1,4-trans content between 55.9% and 85.8%. These values clearly indicate that the stereoregularity of the blocks is not high. The triblock polybutadienes obtained showed a glass transition temperature (T_{g}) equal to about −92° C. and, only in the presence of a 1,4-trans content >70%, a crystallization temperature (T_{c}) equal to about −66° C.

Analogously, Zhang X. et al., in “Polymer Bulletin” (2010), Vol. 65, pages 201-213, describe the synthesis and the characterization of triblock copolymers containing a crystallizable high 1,4-trans polybutadiene block.

Different triblock copolymers containing a crystallizable high 1,4-trans polybutadiene block were synthesized by means of the sequential anionic polymerization of 1,3-butadiene (Bd) with isoprene (Ip) or styrene (St), in the presence of barium salt of di(ethyleneglycol)ethylether/tri-iso-butyl-aluminum/dilithium, (BaDEGEE/TIBA/-DLi) as initiator. The results obtained from the analysis of said triblock copolymers indicated that the medium-3,4-polyisoprene-b-high-1,4-trans-polybutadiene-b-medium 3,4-polyisoprene copolymers and the polystyrene-b-high-1,4-trans-polybutadiene-b-polystyrene copolymers had a polybutadiene block having a high content of 1,4-trans units (maximum content equal to 83%), polyisoprene blocks having a medium content of 3,4 units (content between 22% and 27%) and a total content of 1,4 units (cis+trans) between 72% and 80%, while the polystyrene blocks proved to be atactic. Said copolymers had a glass transition temperature (T_{g}) equal to about −80° C. and a melting point (Tₘ) equal to about 3° C.

From the above, it is therefore evident that the various studies conducted with a view to improving/controlling the stereoregularity of diblock or triblock polymers based on butadiene have proved unsatisfactory.

In more recent years, again with a view to improving/controlling the stereoregularity of diblock or triblock polymers based on butadiene, the use of coordination catalysts based on transition metals, i.e., the catalytic systems used in the stereospecific polymerization of conjugated dienes, has been taken into consideration.

In this regard, for example, Naga N. et al. in “Journal of Polymer Science Part A: Polymer Chemistry” (2003), Vol. 41 (7), pages 939-946 and European patent application EP 1,013,683, indicate the use of the catalyst complex CpTiCl₃/MAO (where Cp=cyclopentadienyl, Ti=titanium, Cl=chlorine, MAO=methylaluminoxane) as catalyst, in order to synthesize block copolymers containing polybutadiene blocks with a 1,4-cis structure and polystyrene blocks with a syndiotactic structure. However, also in this case block copolymers were not obtained, but rather copolymers having random multi-sequences, also due to loss of the living nature of the polymerization.

Ban H. T. et al. in “Journal of Polymer Science Part A: Polymer Chemistry” (2005), Vol. 43, pages 1188-1195, using the catalytic complex Cp*TiMe₃/B(C₆F₅)₃/AlR₃ (wherein Cp=cyclopentadienyl, Ti=titanium, Me=methyl, B(C₆F₅)₃=tris(pentafluorophenyl)borane, AlR₃=trialkylaluminum) and Caprio M. et al. in “Macromolecules” (2002), Vol. 35, pages 9315-9322, using a similar catalytic complex, i.e., CpTiCl₃/Ti(OR₄)MAO) (wherein Cp=cyclopentadienyl, Ti=titanium, Cl=chlorine, R=alkyl, MAO=methylaluminoxane), obtained, operating under specific polymerization conditions, multiblock copolymers containing polystyrene blocks with a syndiotactic structure and polybutadiene blocks with a 1,4-cis structure.

Operating under drastic conditions, in particular at low polymerization temperatures (−20° C. for the syndiotactic polystyrene block and −40° C. for the 1,4-cis polybutadiene block), in order to maintain the living nature of the polymerization, Ban H. T. et al., obtained, with low yields, a copolymer having a syndiotactic polystyrene block (content of syndiotactic units >95%) and a 1,4-cis polybutadiene block (content in 1,4-cis units ≅70%), which showed a melting point (Tₘ) equal to 270° C., attributed to the syndiotactic polystyrene block. Instead, Caprio M. et al., operating with a polymerization temperature between 25° C. and 70° C., obtained, with low yields, a multiblock copolymer having sequences of syndiotactic polystyrene, amorphous polystyrene and polybutadiene prevalently with a 1,4-cis structure. However, using the aforesaid catalytic complexes, the control on the composition of the final copolymer was poor, requiring, among other things, fractionation of the product obtained at the end of the polymerization in order to recover the copolymer of interest.

U.S. Pat. No. 4,255,296 describes a composition comprising a polybutadiene rubber containing a polymer obtained through block polymerization or graft polymerization of 1,4-cis polybutadiene with a syndiotactic 1,2-polybutadiene, the microstructure of which comprises a content of 1,4-cis units between 78% by weight and 93% by weight and a content of syndiotactic 1,2 units between 6% by weight and 20% by weight, at least 40% by weight of said syndiotactic 1,2-polybutadiene being crystallized and having a short fibre form with an average diameter between 0.05 μm and 1 μm and an average length between 0.8 μm and 10 μm. As joining of the blocks was not carried out by synthesis but by post-modification reaction (i.e., graft polymerization) on the 1,4-cis-polybutadiene and on the 1,2, polybutadiene, the polymer obtained probably has multiple junction points: consequently, said polymer is completely different from the copolymers and terpolymers of the present invention, obtained by means of stereospecific polymerization, and in which various polymer blocks, i.e., the polyisoprene block with alternating 1,4-cis/3,4 structure and the polybutadiene and polypentadiene blocks with a syndiotactic 1,2 structure, are joined to each other by means of a single junction point and are not interpenetrated.

U.S. Pat. No. 3,817,968 describes a method for the preparation of equibinary 1,4-cis/1,2 polybutadiene comprising polymerizing the butadiene at a temperature between −80° C. and 100° C., in an inert atmosphere, in a non-aqueous medium, in the presence of a catalyst obtained from the reaction of a trialkylaluminum and dialkoxy molybdenum trichloride. The polybutadiene thus obtained has polybutadiene blocks with a 1,4-cis structure and polybutadiene blocks with a 1,2 structure distributed randomly along the polymer chain, which means that neither polybutadiene blocks with an amorphous 1,4-cis structure, nor polybutadiene blocks with a crystalline 1,2 structure, are present. Consequently, also in this case said polymers are completely different from the stereoblock copolymers and terpolymers of the present invention, obtained by means of stereospecific polymerization and wherein various polymer blocks, i.e., the polyisoprene block with an alternating 1,4-cis/3,4 structure and the polybutadiene and polypentadiene blocks with a syndiotactic 1,2 structure, are joined to each other by means of a single junction point and not interpenetrated.

Decidedly more interesting results were indicated more recently in the scientific and patent literature. For example:

WO 2015/068095 A1 and WO 2015/068094 A1 describe the synthesis of stereoregular diblock polybutadienes in which the two polybutadiene blocks, joined by means of a single junction point, have a different type of stereoregularity. A block having a structure with a high content in 1,4-cis units (>97%), is amorphous, with a glass transition temperature equal to about −110° C.; the second block with a syndiotactic 1,2 structure is crystalline, with a variable melting point in the range 80-140° C. depending on the degree of syndiotacticity of the 1,2 unit. The butadiene is initially polymerized by means of the catalytic system obtained by combining a cobalt complex with a ligand L1 (CoCl₂L1) with methylaluminoxane, to give a polybutadiene with an amorphous cis-1,4 structure. Subsequently, after a given polymerization time, a second ligand L2 is added, which substitutes the ligand L1 on the active site determining a drastic change in catalytic selectivity, from 1,4-cis to syndiotactic 1,2. Therefore, a second polybutadiene block with a crystalline syndiotactic 1,2 is formed. Therefore, this process makes use of the possibility of drastically changing the stereoselectivity of the catalytic site during polymerization, polymerizing a single type of monomer (single monomer, different catalytic system).

The state of the art described above is thus completely different from the subject of the present invention, in which the different selectivity exhibited by the same catalytic system is used to compare the various monomers, i.e., a single catalytic system is used to polymerize different monomers.

In the wake of what is described in the two international patent applications cited above, some rather similar works have recently appeared in the literature:
i) Controlling external diphenylcyclohexylphosphine feeding to achieve cis-1,4-syn-1,2 sequence controlled polybutadienes via cobalt catalyzed 1,3-butadiene polymerization by Dirong Gong, Weilun Ying, Junyi Zhao, Wenxin Li, Yuechao Xu, Yunjie Luo, Xuequan Zhang, Carmine Capacchione, Alfonso Grassi, Journal of Catalysis 377 (2019) 367-377: this describes the synthesis of cis-1,4/1,2 polybutadiene blocks through the addition of diphenylcyclohexylphosphine to a cobalt based catalytic system;
ii) Synthesis of stereoblock polybutadiene possessing cis-1,4 and syndiotactic-1, 2 segments by imino-pyridine cobalt complex-based catalyst through one-pot polymerization process by Bo Dong, Heng Liu, Chuang Peng, Wenpeng Zhao, Wenjie Zheng, Chunyu Zhang, Jifu Bi, Yanming Hu, Xuequan Zhang, European Polymer Journal 108 (2018) 116-123: this describes the synthesis of stereoblock polybutadienes containing cis-1,4 and 1,2 polymer segments through the addition of triphenylphosphine to a cobalt based catalytic system.

As can be observed, almost all of the works reported in the literature concern the preparation of block polymers through the polymerization of a single monomer (butadiene or isoprene), exploiting the possibility of drastically changing the selectivity of the catalyst during the polymerization process, while in the case of the present invention the catalyst remains unchanged during the whole of the polymerization process and its ability to provide polymers with a different structure, and hence property, from different monomers, is exploited.

US 2020/0109229 A1 discloses the preparation of butadiene-isoprene block copolymers by means of iron catalysis, in particular by using catalytic systems obtained by combining phenanthroline or bipyridine Fe(II) complexes with methylaluminoxane. The polybutadiene block of the block copolymer consists of crystalline polybutadiene with an essentially 1,2 syndiotactic structure with 1,2 unit content around 70-80%, the remaining units having a cis-1,4 structure, which represents the “hard” polymer block. The amorphous polyisoprene block is made up of polyisoprene with a predominantly 3,4 atactic structure and a content of 3,4 units around 70%, the remaining units having a cis-1,4 structure, which represents the “soft” polymer block. As indicated above, as polybutadiene and polyisoprene are among the polymers most widely used industrially, in particular for the production of tires, the study of new homo- and copolymers of butadiene and isoprene, but also of pentadiene, is still currently of great interest. Currently, pentadiene is not a monomer that is used industrially, given its high cost and the fact that it is difficult to source on the market; however, in the context of a changing situation, as presently seems to be the case, copolymers containing pentadiene may be very interesting from an industrial point of view for use in the tire sector, given their high content of pentadiene 1,2 units.

Therefore, it would be desirable to obtain stereoblock copolymers of isoprene capable of satisfying the aforesaid requirements.

Moreover, it would be desirable to have a process for the preparation of the aforesaid copolymers that is easily implementable and allows high product yields to be obtained.

Therefore, the main object of the present invention is to provide stereoblock copolymers of isoprene of industrial interest.

Another object of the present invention is to provide a process for the production of stereoblock copolymers of isoprene capable of obtaining high yields by means of the use of a single catalytic system, i.e., without the need to modify the catalytic system during the various steps of polymerization.

These and other objects of the present invention are achieved by means of stereoblock copolymers of isoprene of general formula (I)

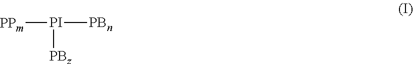

wherein:
PI is a 1,4-cis/3,4 polyisoprene block with alternating structure;
PB is a polybutadiene block with a syndiotactic 1,2 structure in which the content in 1,2 units is ≥80%;
PP is a polypentadiene block with a syndiotactic 1,2 structure in which the content in 1,2 units is ≥90%;
m, n and z can be equal to 1 or equal to 0 according to the following conditions:
   m and n can be simultaneously or alternatively equal to 1;
   if m is equal to 1 then z is equal to 0;
   if n is equal to 1, z can be equal to 1 or equal to 0.

In this way, a series of copolymers of isoprene capable of satisfying the desired requirements are obtained.

A further object of the present invention is to provide a process for the preparation of a copolymer as defined above, comprising the following steps:
a) subjecting to total stereospecific polymerization a first monomer selected from isoprene, pentadiene and butadiene in the presence of a catalytic system obtained from cobalt dichloride, a phosphine of general formula (VI)

Rₘ—P-Phₙ (VI)
wherein m=0, 1, 2 and n=1, 2, 3 and wherein;
   P is trivalent phosphorus;
   R is selected from the group consisting of linear or branched C₁-C₂₀ alkyl; C₃-C₃₀ cycloalkyl; preferably linear or branched C₁-C₁₅ alkyl; C₄-C₁₅ cycloalkyl, more preferably iso-propyl, tert-butyl, cyclopentyl, cyclohexyl;
   Ph is a phenyl group of formula (VII)

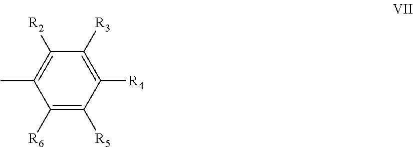

wherein R₂, R₃, R₄ and R₅ are independently selected from the group consisting of H, C₁-C₆ alkyl;

and a co-catalyst selected from the aluminum compounds of general formula (VIII)

Al(X′)ₙ(R₆)₃₋ₙ (VIII)

wherein n=0, 1, 2 and wherein
X′ represents a halogen atom selected from the group consisting of chlorine, bromine, iodine, fluorine:
R₆ is selected from the group consisting of linear or branched C₁-C₂₀ alkyl, cycloalkyl, aryl, all optionally substituted with one or more silicon or germanium atoms; or of general formula (IX)

(R₇)₂—Al—OR—[—Al(R₈)—O-]ₚ-Al—(R₉)₂ (IX)

wherein p is an integer between 0 and 1000 and wherein
R₇, R₈ and R₉, are independently selected from the group consisting of hydrogen, chlorine, bromine, iodine, fluorine, linear or branched C₁-C₂₀ alkyl optionally substituted with one or more silicon or germanium atoms, cycloalkyl optionally substituted with one or more silicon or germanium atoms, aryl optionally substituted with one or more silicon or germanium atoms;
so as to obtain a first stereoblock consisting of units of said first monomer;
b) in the presence of said first stereoblock, subjecting to total stereospecific polymerization a second monomer different from said first monomer, selected from isoprene, pentadiene and butadiene, provided that if said first monomer consists of butadiene or pentadiene said second monomer consists of isoprene, so as to obtain a second stereoblock consisting solely of units of said second monomer, in which said second stereoblock is joined to said first stereoblock in a single junction point;
c) in the presence of said first and second stereoblock in which said second stereoblock consists of isoprene, optionally subjecting a third monomer selected from pentadiene and butadiene to total stereospecific polymerization, so as to obtain a third stereoblock consisting solely of units of said third monomer, wherein said third stereoblock is joined to said second stereoblock in a single junction point; with the exclusion of pentadiene as third stereoblock when said first stereoblock consists of pentadiene units;

wherein in said steps b) and c) said polymerization is carried out in the presence of the same catalytic system of said steps a).

In this way, a process for the preparation of copolymers of isoprene is obtained in which the catalyst remains unvaried during the whole of the polymerization process providing high product yields.

The stereoblock copolymers of the present invention make use of a specific catalytic polymerization process that, having a living nature and being characterized by a high stereoselectivity, makes it possible to obtain diene based stereoblock polymer materials (butadiene, isoprene and pentadiene) in which the various blocks, connected to each other by means of a single junction point, can have a different structure—i.e., alternating cis-1,4/3,4 structure in the case of isoprene, syndiotactic 1,2 structure in the case of butadiene and pentadiene—and morphology, i.e., amorphous in the case of isoprene and crystalline in the case of butadiene and pentadiene. The composition and length of the various blocks can be appropriately managed by choosing the monomer feed ratios, while the microstructure (degree of syndiotacticity) and the thermal properties (melting and crystallization point) of the crystalline blocks with a 1,2 structure by appropriately choosing the type of aromatic phosphine. For the reasons listed below, the aforesaid copolymers can therefore represent a true turning point in the sector of elastomers with pioneering characteristics, both with regard to catalysis and with regard to stereoblock polymer materials:
the stereoblock copolymers of the present invention show an elastic modulus value (G′) significantly higher than that of, for example, cis-1,4 polyisoprene (natural or synthetic), mainly due to the stiffness imparted by the presence of crystalline blocks with a syndiotactic 1,2 structure, based on butadiene and pentadiene. The presence of amorphous blocks bound to crystalline blocks and of different types of monomer units in the polymeric chain (with a cis structure with double bonds in the chain, and with a 1,2 and 3,4 structure with lateral double bonds), lead to an increase in the elasticity of the polymer and means that these new elastomers can be used for many applications, such as the preparation of compounds for tires with improved balance between rolling resistance and wet grip;
the compounds generally used in the tire industry must be cross-linked to develop their elastomeric properties; however, while cross-linking makes it possible to obtain performances that are constant over time, it does not allow end-of life recycling of the product, as in the case of the tire. The copolymers of the present invention have the properties of a thermoplastic elastomer, i.e., exhibit the behavior of a viscoelastic liquid at the processing and moulding temperatures, and elastomeric properties in application, without requiring to pass through a cross-linking process. This characteristic is extremely advantageous in the case of production of tires, allowing end-of-life recycling, but also in the case of many other applications, such as footwear soles, which require non cross-linked elastomers, with considerable benefits with regard to environmental sustainability;
the crystalline blocks with a syndiotactic 1,2 structure, chemically bound to the amorphous block with elastomeric characteristics, have a behaviour similar to that of fillers (e.g., silica) which are used in the preparation of compounds, and thus allow a noteworthy decrease in the amounts normally used resulting in a reduction in costs;
the presence of the amorphous block with alternating cis-1,4/3,4 structure based on isoprene allows improved miscibility and compatibilization with natural rubber, which represents one or the main components in the production of tires for industrial vehicles.

The stereoblock copolymers according to the present invention can advantageously be used to produce tire compounds, in particular in the formulation of compounds for tire treads, also with a high natural rubber (NR) content, having improved balance between rolling resistance and wet grip. This is possible given the compatibility of the copolymers according to the invention with natural rubber NR, due to the presence of the amorphous polyisoprene block with alternating cis-1,4/3,4 structure.

In fact, it is known that the strict application conditions linked to the use of tires require elastomeric compositions destined for this sector to be capable of a good balance between mechanical and dynamic-mechanical properties and performance on the road. In general, it is difficult to obtain an optimal balance of all the required properties, in particular it is difficult to obtain an optimal balance between rolling resistance, wet grip and mechanical and dynamic-mechanical properties: in fact, these properties are often in contrast with one another.

The consolidated state of the art in this sector indicates that, in order to improve the performance of tires, such as rolling resistance, wet grip, mechanical and dynamic properties, efforts have mainly been concentrated in three directions
optimizing the molecular structures of amorphous polymers (for example, S-SBR);
developing new reinforcing fillers, for example, silica;
developing functionalization methods for elastomeric polymers and reinforcing fillers.

The use of the stereoblock copolymers containing two or more blocks according to the invention, in which the crystalline block acts as filler, as stiff reinforcement and as cross-linking point, and the amorphous block behaves in an elastic manner, allows further improvement of the aforesaid performance. Therefore, the copolymers described here, in the appropriate conditions and compositions, show properties very similar to those of an elastic lattice filled with a reinforcing filler.

The copolymers according to the invention have the considerable advantage of possessing a chemical bond between the amorphous and crystalline blocks, the presence of which has a strong influence on the morphology of the copolymer and on the mechanical and dynamic-mechanical properties of the cross-linked elastomeric composition. Moreover, it is important to point out that the presence of a chemical bond between the blocks allows a rigid phase that acts as reinforcing filler bound to the elastomeric phase to be obtained from the outset, without the need to proceed with a functionalization of the copolymer or with a compatibilization of the immiscible phases, as occurs in the case of elastomeric compositions comprising different elastomeric polymers, for example mechanical compounds of 1,4 cis polybutadiene and natural rubber (NR).

Moreover, they have both the elastic properties of the elastomeric polymers and the reinforcing properties of the reinforcing fillers, which are the two main characteristics required of elastomeric compositions that can be used in particular in the tire sector. The block copolymers currently used mainly in the manufacture of tires are, for example, SBS (styrene-butadiene-styrene) and SIS (styrene-isoprene-styrene), wherein the block with greater stiffness (hard block) consists of amorphous polystyrene, the glass transition temperature of which, above which the hard block definitively loses its characteristics of stiffness, cannot exceed 100° C. Moreover, in the aforesaid block copolymers (SBS and SIS), the block with the least stiffness (soft block) does not have a high stereoregularity and therefore the possibility of crystallization is absent. This fact considerably lowers the dynamic-mechanical properties of the elastomeric composition, in particular the fatigue strength.

The copolymers according to the invention, having a melting point that can be modulated in the range 60-140° C., depending on the type of catalyst used, make it possible to obtain cross-linkable elastomeric compositions, but not necessarily. These copolymers can therefore be used advantageously in the production of tires, in particular tire treads, with an improved balance between rolling resistance, wet grip and mechanical and dynamic-mechanical properties. In particular, improved values of tensile modulus at 100% of elongation (Modulus 100%) and 200% of elongation (Modulus 200%), and improved dynamic-mechanical properties (in terms of tan delta values at 0° C. at 0.1% of deformation and/or tan delta at 60° C. at 5% of deformation). Moreover, these cross-linkable elastomeric compositions, i.e., the copolymers according to the invention, show good maximum torque values (MH).

The copolymers according to the present invention, associated with the catalytic process developed for their preparation, allow the preparation of compounds for applications in a variety of fields, such as tires, soles and technical articles, with improved properties with respect to those currently available.

In particular, with the new compounds it is possible to develop tires that can be used both in summer and in winter, but with optimal characteristics for both these applications. Today, all season tires have characteristics that are a compromise between winter and summer tires, and consequently with lower performance for both these seasons.

The stereoblock polymers characterized by non-crosslinked compounds could make the products obtained with this technology easier to recycle and more environmentally friendly. Moreover, considering that they are based on a very new technology and that the constituent blocks (soft amorphous block and hard crystalline block) can be modulated as desired in relation to molecular weight and length, type and degree of stereoregularity, and thermal properties (melting, crystallization and glass transition temperatures), the potential applications of these new polymers stretch beyond tires and involve a wide range of commercial segments, both in the thermoplastic and in elastomeric fields.

The copolymers according to the present invention can be applied in the preparation of stretch hood packaging films based on polyethylene compounds, to greatly improve their elastomeric properties.

These new stereoblock diene polymers can compete in the specific sectors of S-SBR, SBS and SIS, eroding the market volumes for these polymer families as a result of evident improvements in the application.

Therefore, the present invention relates to stereoblock copolymers and terpolymers formed of:
i) a 1,4-cis/3,4 polyisoprene block with alternating structure and of a polybutadiene block with a syndiotactic 1,2 structure (content in 1,2 units ≥80%), having the following formula:

PI-PB or PB-PI
wherein:
   PI corresponds to the 1,4-cis/3,4 polyisoprene block with perfectly alternating structure;
   PB corresponds to the polybutadiene block with a syndiotactic 1,2 structure (content in 1,2 units ≥80%); essentially free of 1,4-trans units.
ii) a 1,4-cis/3,4 polyisoprene block with alternating structure and of a polypentadiene block with a syndiotactic 1,2 structure (content in 1,2 units ˜99%), having the following formula:

PI-PP or PP-PI
wherein:
   PI corresponds to the 1,4-cis/3,4 polyisoprene block with a perfectly alternating structure;
   PP corresponds to the polypentadiene block with a syndiotactic 1,2 structure (content in 1,2 units ˜99%); essentially free of 1,4-trans units.
iii) a polypentadiene block with a syndiotactic 1,2 structure (content in 1,2 units ˜99%), a 1,4-cis/3,4 polyisoprene block with alternating structure, and a polybutadiene block with a syndiotactic 1,2 structure (content in 1,2 units ≥80%), having the following formula

PP-PI-PB or PB-PI-PP
wherein:
   PI corresponds to the 1,4-cis/3,4 polyisoprene block with a perfectly alternating structure;
   PP corresponds to the polypentadiene block with a syndiotactic 1,2 structure (content in 1,2 units ˜99%);
   PB corresponds to the polybutadiene block with a syndiotactic 1,2 structure (content in 1,2 units ≥80%), essentially free of 1,4-trans units.
iv) a polybutadiene block with a syndiotactic 1,2 structure (content in 1,2 units ≥80%), a 1,4-cis/3,4 polyisoprene block with alternating structure, and also a polybutadiene block with a syndiotactic 1,2 structure (content in 1,2 units ≥80%), having the following formula

PB-PI-PB
wherein:
   PI corresponds to the 1,4-cis/3,4 polyisoprene block with a perfectly alternating structure;
   PB corresponds to the polybutadiene blocks with a syndiotactic 1,2 structure (content in 1,2 units ≥80%), essentially free of 1,4-trans units.

In the present description, the term copolymer is meant as a polymer deriving from more than one type of monomer. Copolymers obtained from the copolymerization of two different monomers can be defined bipolymers, those obtained from the copolymerization of three different monomers can be defined terpolymers, etc. These definitions are taken from PAC, 1996, 68, 2287 (Glossary of basic terms in polymer science (IUPAC Recommendations 1996), page 2300).

According to the present invention, the terms “butadiene/isoprene stereoblock copolymer, pentadiene/isoprene stereoblock copolymer, pentadiene/isoprene/butadiene stereoblock terpolymer and butadiene/isoprene/butadiene stereoblock terpolymer” are meant as:
butadiene/isoprene copolymers in which only polyisoprene and polybutadiene blocks having a different structure are present, respectively with a perfectly alternating 1,4-cis/3,4 structure and with a syndiotactic 1,2 structure, joined to each other through a single junction point and not interpenetrated;
pentadiene/isoprene copolymers in which only two polyisoprene and polypentadiene blocks having a different structure are present, respectively with a perfectly alternated 1,4-cis/3,4 structure and with a syndiotactic 1,2 structure, joined to each other by means of a single junction point and not interpenetrated;
pentadiene/isoprene/butadiene terpolymers in which only three polypentadiene, polyisoprene and polybutadiene blocks having a different structure are present, respectively with a syndiotactic 1,2 structure, with a perfectly alternated 1,4-cis/3,4 structure and with a syndiotactic 1,2 structure, joined to each other by means of a single junction point and not interpenetrated;
butadiene/isoprene/butadiene terpolymers in which only three polybutadiene, polyisoprene and polybutadiene blocks having a different structure are present, respectively with a syndiotactic 1,2 structure, with a perfectly alternated 1,4-cis/3,4 structure and with a syndiotactic 1,2 structure, joined to each other by means of a single junction point and not interpenetrated;

According to the present invention, the term “essentially free of 1,4-trans units” means that, when present, said 1,4-trans units are present in quantities of less than 3% molar, preferably less than 1% molar, with respect to the total molar amount of the monomer units in the stereoblock copolymers and terpolymers.

For the purpose of the present description and of the appended claims, unless otherwise specified, the definitions of the numerical ranges always comprise the extremes.

For the purpose of the present description and of the appended claims, the term “comprising” also includes the terms “which essentially consists of” or “which consists of”.

In accordance with a preferred embodiment of the present invention, the isoprene/butadiene stereoblock copolymer, has the following characteristics:
under infrared (FT-IR) analysis the bands typical of the 1,4-cis and 3,4 units of the isoprene units, centred at 840/1375 cm⁻¹ and at 890 cm⁻¹, respectively, and of the 1,2 butadiene units, centred at 911 cm⁻¹.

The infrared (FT-IR) analysis and the ¹³C-NMR analysis were carried out as indicated below in the paragraph “Analysis and characterization methods”.

In accordance with a further preferred embodiment of the present invention, in said isoprene-butadiene stereoblock copolymer:
the isoprene block with alternating 1,4-cis/3,4 structure can have a glass transition temperature (T_{g}) between −18° C. and −30° C., preferably between −10° C. and −30° C.;
the butadiene block with a syndiotactic 1,2 structure can have a glass transition temperature (T_{g}) between −10° C. and −24° C., preferably between −14° C. and −24° C., a melting point (Tₘ) between 70° C. and 140° C., preferably between 95° C. and 140° C., and a crystallization temperature (T_{c}) between 55° C. and 130° C., preferably between 60° C. and 130° C.

It should be pointed out that the wide range within which the melting point (Tₘ) and the crystallization temperature (T_{c}) of the block with a 1,2 structure vary can be attributed to the different content of syndiotactic triads [(rr) %], which depends on the type of monodentate aromatic phosphine used in polymerization, i.e., the degree of stereoregularity, namely the content of syndiotactic triads [(rr) %] increases as the steric hindrance of the aromatic phosphine used increases.

Said glass transition temperature (T_{g}), said melting point (Tₘ) and said crystallization temperature (T_{c}), were determined by means of DSC (Differential Scanning Calorimetry) thermal analysis, which was carried out as indicated below in the paragraph “Analysis and characterization methods”.

In accordance with a further preferred embodiment of the present invention, said isoprene/butadiene stereoblock copolymer can have a polydispersion index (PDI) corresponding to the M_{w}/Mₙ ratio (M_{w}=weight average molecular weight; Mₙ=number average molecular weight) between 1.5 and 2.3.

Said polydispersion index (PDI) was determined by means of GPC (Gel Permeation Chromatography) which was carried out as indicated below in the paragraph “Analysis and characterization methods”.

It should be pointed out that the presence of a narrow and monomodal peak, i.e., of a polydispersion index (PDI) between 1.9 and 2.2, indicates the presence of a homogeneous polymeric species, at the same time excluding the presence of two different homopolymers (i.e., homopolymers of isoprene with an alternating cis-1,4/3,4 structure and of butadiene with a syndiotactic 1,2 structure) separate and not joined to each other.

It should also be pointed out that the isolated fractions (i.e., extract soluble in ether and residue insoluble in ether) obtained by subjecting the isoprene-butadiene stereoblock copolymer of the present invention to continuous extraction with diethylether at boiling point for 4 hours always have a composition/structure completely analogous to that of the “nascent” starting polymer. The isoprene-butadiene stereoblock copolymer of the present invention, subjected to atomic force microscopy (AFM), has two clearly distinct domains relating to the isoprene block with an alternating 1,4-cis/3,4 structure and to the butadiene block with a syndiotactic 1,2 structure and, in particular, a homogeneous distribution of said domains.

Said atomic force microscopy (AFM) was carried out as indicated below in paragraph “Analysis and characterization methods”.

In accordance with a preferred embodiment of the present invention, in said isoprene-butadiene stereoblock copolymer the polyisoprene block with a perfectly alternating 1,4-cis/3,4 structure (molar ratio cis-1,4/3,4 equal to 50/50) is amorphous, at room temperature under quiescent conditions, i.e., not subjected to stress.

It should be pointed out that in said isoprene-butadiene copolymer, in the isoprene block with an alternating cis-14/3,4 structure, the 1,4 trans and 1,2 units are practically negligible.

In the isoprene-butadiene stereoblock copolymer of the present invention, the polybutadiene block with a syndiotactic 1,2 structure can have a varying degree of crystallinity depending on the content of syndiotactic triads [(rr) %], namely on the type of monodentate aromatic phosphine used: in particular, the degree of crystallinity increases as the content of syndiotactic triads [(rr) %] increases. Preferably, said content of syndiotactic triads [(rr) %] can be greater than or equal to 15%, preferably between 60% and 90%.

It should be pointed out that, in the isoprene-butadiene stereoblock copolymer of the present invention, also in the case in which the polybutadiene block with a 1,2 structure is characterized by a low content of syndiotactic triads [(rr) %] (i.e., a content between 15% and 20%) and, therefore, has low crystallinity, the content of 1,2 units always remains greater than or equal to 80%.

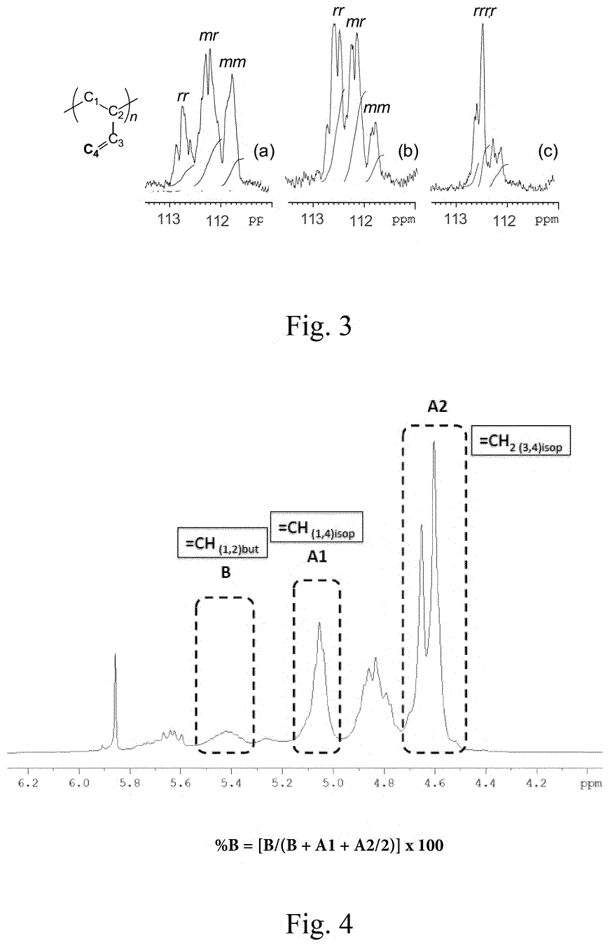

The content of syndiotactic triads [(rr) %] was determined by means of ¹³C-NMR spectroscopy analysis (see FIG. 3) which was carried out as indicated below in the paragraph “Analysis and characterization methods”.

In accordance with a preferred embodiment of the present invention, in said isoprene/butadiene stereoblock copolymer the molar ratio between the isoprene and butadiene units can be between 10:90 and 90:10, preferably between 20:80 and 80:20. The percentage of isoprene and butadiene units was determined by means of ¹H NMR analysis of the copolymers obtained (see FIG. 4).

In accordance with a preferred embodiment of the present invention, said isoprene-butadiene stereoblock copolymer can have a weight average molecular weight (M_{w}) between 100000 g/mol and 800000 g/mol, preferably between 120000 g/mol and 400000 g/mol.

In accordance with a preferred embodiment of the present invention the isoprene-pentadiene stereoblock copolymer, has the following characteristics:
under infrared (FT-IR) analysis the bands typical of the 1,4-cis and 3,4 units of the isoprene units, centred at 840/1375 cm⁻¹ and at 890 cm⁻¹, respectively, and of the pentadiene 1,2 units, centred at 963 cm⁻¹;

The infrared (FT-IR) analysis and the ¹³C-NMR analysis were carried out as indicated below in the paragraph “Analysis and characterization methods”.

In accordance with a further preferred embodiment of the present invention, in said isoprene-pentadiene stereoblock copolymer:
the isoprene block with alternating 1,4-cis/3,4 structure can have a glass transition temperature (T_{g}) lower than or equal to −10° C. and −30° C., preferably between −18° C. and −30° C.;
the pentadiene block with a syndiotactic 1,2 structure can have a glass transition temperature (T_{g}) between −10° C. and −24° C., preferably between −14° C. and −24° C., a melting point (Tₘ) between 80° C. and 160° C., preferably between 95° C. and 160° C., and a crystallization temperature (T_{c}) greater than or equal to 65° C., preferably between 60° C. and 135° C.

It should be pointed out that the wide range within which the melting point (Tₘ) and the crystallization temperature (T_{c}) of the block with a 1,2 structure vary can be attributed to the different content of syndiotactic triads [(rr) %], which depends on the type of monodentate aromatic phosphine used in polymerization, [i.e., the degree of stereoregularity, namely the content of syndiotactic triads [(rr) %] increases as the steric hindrance of the aromatic phosphine used increases].

Said glass transition temperature (T_{g}), said melting point (Tₘ) and said crystallization temperature (T_{c}), were determined by means of DSC (Differential Scanning Calorimetry) thermal analysis, which was carried out as indicated below in the paragraph “Analysis and characterization methods”.

In accordance with a further preferred embodiment of the present invention, said isoprene-pentadiene stereoblock copolymer can have a polydispersion index (PDI) corresponding to the ratio M_{w}/Mₙ(M_{w}=weight average molecular weight; Mₙ=number average molecular weight) between 1.5 and 2.3.

Said polydispersion index (PDI) was determined by means of GPC (Gel Permeation Chromatography), which was carried out as indicated below in the paragraph “Analysis and characterization methods”.

It should be pointed out that the presence of a narrow and monomodal peak, i.e., of a polydispersion index (PDI) between 1.5 and 2.3, indicates the presence of a homogeneous polymeric species, at the same time excluding the presence of two different homopolymers (i.e., homopolymers of isoprene with an alternating cis-1,4/3,4 structure and of pentadiene with a syndiotactic 1,2 structure) separate and not joined to each other.

It should also be pointed out that the isolated fractions (i.e., extract soluble in ether and residue insoluble in ether) obtained by subjecting the isoprene-pentadiene stereoblock copolymer of the present invention to continuous extraction with diethylether at boiling point for 4 hours always have a composition/structure completely analogous to that of the “nascent” starting polymer. In accordance with a preferred embodiment of the present invention, in said isoprene-pentadiene stereoblock copolymer, the polyisoprene block with a perfectly alternating 1,4-cis/3,4 structure (molar ratio cis-1,4/3,4 equivalent to 50/50) is amorphous, at room temperatures under quiescent conditions (i.e., not subjected to stress).

It should be pointed out that in said isoprene/pentadiene stereoblock copolymer, in the isoprene block with alternating cis-1,4/3,4 structure the 1,4 trans and 1,2 units are practically negligible. In the isoprene/pentadiene stereoblock copolymer of the present invention, the polypentadiene block with a syndiotactic 1,2 structure can have a varying degree of crystallinity depending on the content of syndiotactic triads [(rr) %], namely the type of monodentate aromatic phosphine used: in particular, the degree of crystallinity increases as the content of syndiotactic triads [(rr) %] increases. Preferably, said content of syndiotactic triads [(rr) %] can be greater than or equal to 15%, preferably between 60% and 90%.

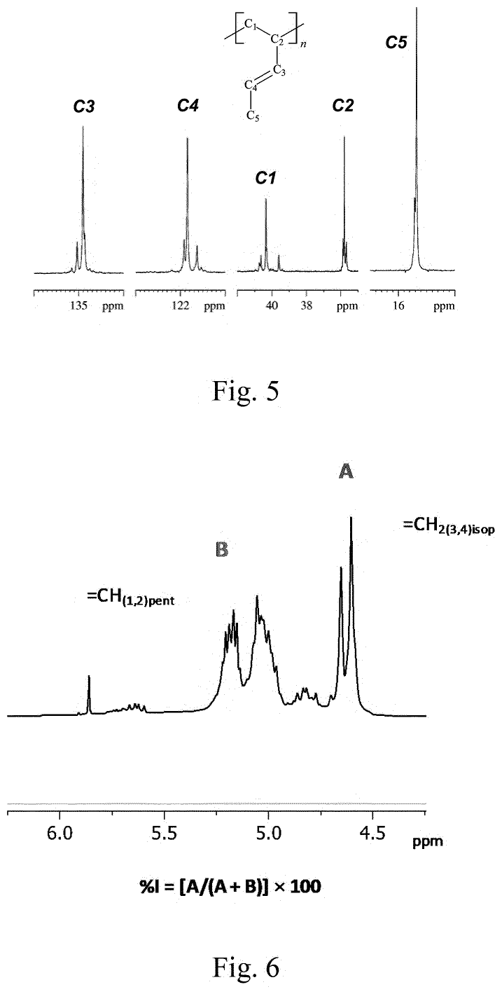

It should be pointed out that, in the isoprene-pentadiene stereoblock copolymer of the present invention, also in the case in which the polypentadiene block with a 1,2 structure is characterized by a low content of syndiotactic triads [(rr) %] (i.e., a content between 15% and 20%) and, therefore, has low crystallinity, the content of 1,2 units always remains equal to 99%. The content of syndiotactic triads [(rr) %] was determined by means of ¹³C-NMR spectroscopy analysis (see FIG. 5), which was carried out as indicated below in the paragraph “Analysis and characterization methods”.

In accordance with a preferred embodiment of the present invention, in said isoprene-pentadiene stereoblock copolymer, the molar ratio between the isoprene units and the pentadiene units can be between 10:90 and 90:10, preferably between 20:80 and 80:20. The percentage of isoprene and pentadiene units was determined by means of ¹H NMR analysis of the copolymers obtained (see FIG. 6) following the indications provided in the literature and considering that the isoprene block has a practically equimolar (50:50) cis-1,4/3,4 structure [Sato, H., et al., in “Journal of Polymer Science: Polymer Chemistry Edition” (1979), Vol. 17, Issue 11, pages 3551-3558 for polyisoprene, from a) Beebe, D. H.; Gordon, C. E.; Thudium, R. N.; Throckmorton, M. C.; Hanlon, T. L. J. Polym. Sci: Polym. Chem. Ed. 1978, 16, 2285; b) Ciampelli, F.; Lachi, M. P.; Tacchi Venturi, M.; Porri, L. Eur. Polym. J. 1967, 3, 353 and G. Ricci, T. Motta, A. Boglia, E. Alberti, L. Zetta, F. Bertini, P. Arosio, A. Famulari, S. V. Meille “Synthesis, characterization and crystalline structure of syndiotactic 1,2 polypentadiene: the trans polymer.” Macromolecules 2005, 38, 8345-8352 for polypentadiene].

In accordance with a preferred embodiment of the present invention, said isoprene/pentadiene stereoblock copolymer can have a weight average molecular weight (M_{w}) between 100000 g/mol and 600000 g/mol, preferably between 150000 g/mol and 400000 g/mol.

In accordance with a preferred embodiment of the present invention, the pentadiene/isoprene/butadiene stereoblock terpolymer has the following characteristics:
under infrared (FT-IR) analysis the bands typical of the 1,4-cis and 3,4 units of the isoprene units, centred at 840/1375 cm⁻¹ and at 890 cm⁻¹, respectively, of the butadiene 1,2 units, centred at 911 cm⁻¹, and of the pentadiene trans-1,2 units, centred at 963 cm⁻¹;

The infrared (FT-IR) analysis and ¹³C-NMR analysis were carried out as indicated below in the paragraph “Analysis and characterization methods”.

In accordance with a further preferred embodiment of the present invention, in said pentadiene/isoprene/butadiene stereoblock terpolymer:
the pentadiene block with a syndiotactic 1,2 structure can have a melting point (Tₘ) between 80° C. and 160° C., preferably between 95° C. and 160° C., and a crystallization temperature (T_{c}) between 65° C. and 135° C., preferably between 60° C. and 135° C.
the isoprene block with an alternating 1,4-cis/3,4 structure can have a glass transition temperature (T_{g}) between −10° C. and −30° C., preferably between −30° C. and −10° C.;
the butadiene block with a syndiotactic 1,2 structure can have a glass transition temperature (T_{g}) between −10° C. and −24° C., preferably between −14° C. and −24° C., a melting point (Tₘ) between 70° C. and 140° C., preferably between 95° C. and 140° C., and a crystallization temperature (T_{c}) between 55° C. and 130° C., preferably between 60° C. and 130° C.

It should be pointed out that the wide range within which the melting point (Tₘ) and the crystallization temperature (T_{c}) of the blocks with a 1,2 structure vary can be attributed to the different content of syndiotactic triads [(rr) %], which depends on the type of monodentate aromatic phosphine used in polymerization, [i.e., the degree of stereoregularity, namely the content of syndiotactic triads [(rr) %] increases as the steric hindrance of the aromatic phosphine used increases].

Said glass transition temperature (T_{g}), said melting point (Tₘ) and said crystallization temperature (T_{c}), were determined by means of DSC (Differential Scanning Calorimetry) thermal analysis, which was carried out as indicated below in the paragraph “Analysis and characterization methods”.

In accordance with a further preferred embodiment of the present invention, said pentadiene-isoprene-butadiene stereoblock terpolymer can have a polydispersion index (PDI) corresponding to the ratio M_{w}/Mₙ(M_{w}=weight average molecular weight; Mₙ=number average molecular weight) between 1.5 and 2.3.

Said polydispersion index (PDI) was determined by means of GPC (Gel Permeation Chromatography), which was carried out as indicated below in the paragraph “Analysis and characterization methods”.

It should be pointed out that the presence of a narrow and monomodal peak, i.e., of a polydispersion index (PDI) between 1.95 and 2.3, indicates the presence of a homogeneous polymeric species, at the same time excluding the presence of three different homopolymers (i.e., homopolymers of pentadiene with a syndiotactic trans-1,2 structure, of isoprene with an alternating cis-1,4/3,4 structure and of butadiene with a syndiotactic 1,2 structure) separate and not joined to each other.

It should also be pointed out that the isolated fractions (i.e., extract soluble in ether and residue insoluble in ether) obtained by subjecting the pentadiene-isoprene-butadiene stereoblock terpolymer of the present invention to continuous extraction with diethylether at boiling point for 4 hours always have a composition/structure completely analogous to that of the “nascent” starting polymer.

In accordance with a preferred embodiment of the present invention, in said pentadiene-isoprene-butadiene stereoblock terpolymer, the polyisoprene block with a perfectly alternating 1,4-cis/3,4 structure (molar ratio cis-1,4/3,4 equal to 50/50) is amorphous, at room temperature in quiescent conditions (i.e., not subjected to stress).

It should be pointed out that in said pentadiene/isoprene/butadiene stereoblock terpolymer, in the isoprene block with alternating cis-14/3,4 structure the 1,4 trans and 1,2 units are practically negligible.

In the pentadiene/isoprene/butadiene stereoblock terpolymer of the present invention, the polybutadiene block with a syndiotactic 1,2 structure and the polypentadiene block with a syndiotactic trans-1,2 structure can have a varying degree of crystallinity depending on the content of syndiotactic triads [(rr) %], namely the type of monodentate aromatic phosphine used: in particular, the degree of crystallinity increases as the content of syndiotactic triads [(rr) %] increases. Preferably, said content of syndiotactic triads [(rr) %] can be greater than or equal to 15%, preferably between 60% and 90%.

It should be pointed out that in the pentadiene-isoprene-butadiene stereoblock terpolymer of the present invention, also in the case in which the polypentadiene blocks with a 1,2 structure are characterized by a low content of syndiotactic triads [(rr) %] (i.e., a content between 15% and 20%) and, therefore, have low crystallinity, the content of 1,2 units always remains greater than or equal to 80% for the butadiene block and equal to 99% for the pentadiene block.

The content of syndiotactic triads [(rr) %], in the case of 1,2 butadiene and 1,2 pentadiene blocks was determined by means of ¹³C-NMR spectroscopy analysis (see FIGS. 3 and 5), which was carried out as indicated below in the paragraph “Analysis and characterization methods”. In accordance with a preferred embodiment of the present invention, in said pentadiene/isoprene/butadiene stereoblock terpolymer the molar ratio between the pentadiene, isoprene and butadiene units can be between 10:80:10 and 30:40:30. The percentage of pentadiene, isoprene and butadiene units were determined through ¹H NMR analysis of the terpolymers obtained.

In accordance with a preferred embodiment of the present invention, said pentadiene-isoprene-butadiene stereoblock terpolymer can have a weight average molecular weight (M_{w}) between 100000 g/mol and 800000 g/mol, preferably between 150000 g/mol and 400000 g/mol.

In accordance with a preferred embodiment of the present invention, the butadiene/isoprene/butadiene stereoblock terpolymer has the following characteristics:
under infrared (FT-IR) analysis the bands typical of the 1,4-cis and 3,4 units of the isoprene units, centred at 840/1375 cm⁻¹ and at 890 cm⁻¹, respectively, and of the 1,2 butadiene units, centred at 911 cm⁻¹;

The infrared (FT-IR) analysis and ¹³C-NMR analysis were carried out as indicated below in the paragraph “Analysis and characterization methods”.

In accordance with a further preferred embodiment of the present invention, in said butadiene/isoprene/butadiene stereoblock terpolymer:
the butadiene blocks with a syndiotactic 1,2 structure can have a melting point (Tₘ) between 80° C. and 160° C., preferably between 95° C. and 160° C., and a crystallization temperature (T_{c}) between 65° C. and 135° C., preferably between 60° C. and 135° C.
the isoprene block with alternating 1,4-cis/3,4 structure can have a glass transition temperature (T_{g}) between −10° C. and −30° C., preferably between −18° C. and −10° C.;
the butadiene blocks with a syndiotactic 1,2 structure can have a glass transition temperature (T_{g}) between −10° C. and −24° C., preferably between −14° C. and −24° C., a melting point (Tₘ) between 70° C. and 140° C., preferably between 95° C. and 140° C., and a crystallization temperature (T_{c}) between 55° C. and 130° C., preferably between 60° C. and 130° C.

It should be pointed out that the wide range within which the melting point (Tₘ) and the crystallization temperature (T_{c}) of the block with a 1,2 structure vary can be attributed to the different content of syndiotactic triads [(rr) %], which depends on the type of monodentate aromatic phosphine used in polymerization, [i.e., the degree of stereoregularity, namely the content of syndiotactic triads [(rr) %] increases as the steric hindrance of the aromatic phosphine used increases].

Said glass transition temperature (T_{g}), said melting point (Tₘ) and said crystallization temperature (T_{c}), were determined by means of DSC (Differential Scanning Calorimetry) thermal analysis, which was carried out as indicated below in the paragraph “Analysis and characterization methods”.

In accordance with a further preferred embodiment of the present invention, said butadiene-isoprene-butadiene stereoblock terpolymer can have a polydispersion index (PDI) corresponding to the ratio M_{w}/Mₙ(M_{w}=weight average molecular weight; Mₙ=number average molecular weight) between 1.5 and 2.3.

Said polydispersion index (PDI) was determined by means of GPC (Gel Permeation Chromatography), which was carried out as indicated below in the paragraph “Analysis and characterization methods”.

It should be pointed out that the presence of a narrow and monomodal peak, i.e., of a polydispersion index (PDI) between 1.5 and 2.3, indicates the presence of a homogeneous polymeric species, at the same time excluding the presence of three different homopolymers (i.e., homopolymers of butadiene with a syndiotactic trans-1,2 structure, and of isoprene with an alternating cis-1,4/3,4 structure) separate and not joined to each other.

It should also be pointed out that the isolated fractions (i.e., extract soluble in ether and residue insoluble in ether) obtained by subjecting the butadiene-isoprene-butadiene stereoblock terpolymer of the present invention to continuous extraction with diethylether at boiling point for 4 hours always have a composition/structure completely analogous to that of the “nascent” starting polymer.

The butadiene-isoprene-butadiene stereoblock terpolymer of the present invention, subjected to atomic force microscopy (AFM), has two clearly distinct domains relating to the isoprene block with an alternating 1,4-cis/3,4 structure and to the butadiene block with a syndiotactic 1,2 structure and, in particular, a homogeneous distribution of said domains.

In accordance with a preferred embodiment of the present invention, in said butadiene-isoprene-butadiene stereoblock terpolymer, the polyisoprene block with a perfectly alternating 1,4-cis/3,4 structure (molar ratio cis-1,4/3,4 equal to 50/50) is amorphous, at room temperature in quiescent conditions (i.e., not subjected to stress).

It should be pointed out that in said butadiene-isoprene-butadiene stereoblock terpolymer, in the isoprene block with alternating cis-14/3,4 structure the 1,4 trans and 1,2 units are practically negligible.

In the butadiene-isoprene-butadiene stereoblock terpolymer of the present invention, the polybutadiene blocks with a syndiotactic 1,2 structure can have a varying degree of crystallinity depending on the content of syndiotactic triads [(rr) %], namely of the type of monodentate aromatic phosphine used: in particular, the degree of crystallinity increases as the content of syndiotactic triads [(rr) %] increases. Preferably, said content of syndiotactic triads [(rr) %] can be greater than or equal to 15%, preferably between 60% and 90%.

It should be pointed out that in the butadiene-isoprene-butadiene stereoblock terpolymer of the present invention, also in the case in which the polybutadiene blocks with a 1,2 structure are characterized by a low content of syndiotactic triads [(rr) %] (i.e., a content between 15% and 20%) and, therefore, have low crystallinity, the content of 1,2 units always remains greater than or equal to 80%.

The content of syndiotactic triads [(rr) %], in the case of 1,2, butadiene blocks, was determined by means of ¹³C-NMR spectroscopy analysis (see FIG. 3), which was carried out as indicated below in the paragraph “Analysis and characterization methods”.

In accordance with a preferred embodiment of the present invention, in said butadiene/isoprene/butadiene stereoblock terpolymer the molar ratio between the butadiene and isoprene units can be between 20:80 and 60:40. The percentage of isoprene and butadiene units was determined through ¹H NMR analysis of the terpolymers obtained.

In accordance with a preferred embodiment of the present invention, said butadiene-isoprene-butadiene stereoblock terpolymer can have a weight average molecular weight (M_{w}) between 100000 g/mol and 800000 g/mol, preferably between 150000 g/mol and 400000 g/mol.

As stated above, the present invention also relates to a process for the preparation of:
an isoprene/butadiene stereoblock copolymer formed of a polyisoprene block with a perfectly alternating 1,4-cis/3,4 structure and of a polybutadiene block with a syndiotactic 1,2 structure;
an isoprene/pentadiene stereoblock copolymer formed of a polyisoprene block with a perfectly alternating 1,4-cis/3,4 structure and of a polypentadiene block with a syndiotactic 1,2 structure;
a pentadiene-isoprene-butadiene stereoblock terpolymer formed of a polypentadiene block with a syndiotactic 1,2 structure, of polyisoprene with a perfectly alternating 1,4-cis/3,4 structure and of a polybutadiene block with a syndiotactic 1,2 structure;
a butadiene-isoprene-butadiene stereoblock terpolymer formed of a polybutadiene block with a syndiotactic 1,2 structure, of polyisoprene with a perfectly alternating 1,4-cis/3,4 structure and of a further polybutadiene block with a syndiotactic 1,2 structure.

According to an embodiment of the present invention, the process for the preparation of the stereoblock copolymers and terpolymers set forth above comprises:
subjecting to total stereospecific polymerization isoprene, or alternatively butadiene, in the presence of a catalytic system obtained from cobalt dichloride with the addition of a phosphine and methylaluminoxane, so as to obtain polyisoprene with a perfectly alternating 1,4-cis/3,4 living structure, or alternatively a polybutadiene with a syndiotactic 1,2 living structure; subsequently adding butadiene, or alternatively isoprene, and continuing said stereospecific polymerization, so as to obtain said isoprene-butadiene stereoregular copolymer formed of a polyisoprene block with a perfectly alternating 1,4-cis/3,4 structure and of a polybutadiene block with a syndiotactic 1,2 structure;
subjecting to total stereospecific polymerization isoprene, or alternatively pentadiene, in the presence of a catalytic system obtained from cobalt dichloride with the addition of a phosphine and methylaluminoxane, so as to obtain polyisoprene with a perfectly alternating 1,4-cis/3,4 living structure, or alternatively a polypentadiene with a syndiotactic 1,2 living structure; subsequently adding 1,3-pentadiene, or alternatively isoprene, and continuing said stereospecific polymerization, so as to obtain said pentadiene-isoprene stereoblock copolymer formed of a polyisoprene block with a perfectly alternating 1,4-cis/3,4 structure and of a polypentadiene block with a syndiotactic 1,2 structure;
subjecting to total stereospecific polymerization pentadiene, or alternatively butadiene, in the presence of a catalytic system obtained from cobalt dichloride with the addition of a phosphine with methylaluminoxane, so as to obtain polypentadiene with a syndiotactic 1,2 living structure, or alternatively a polybutadiene with a syndiotactic 1,2 living structure; subsequently adding isoprene, and continuing said stereospecific polymerization, so as to obtain a second polyisoprene block with a perfectly alternating 1,4-cis/3,4 structure; finally, adding butadiene, or alternatively pentadiene, so as to obtain a third polybutadiene block with a syndiotactic 1,2 structure, or alternatively a polypentadiene block with a syndiotactic 1,2 structure;
subjecting to total stereospecific polymerization butadiene, in the presence of a catalytic system obtained from cobalt dichloride with the addition of a phosphine with methylaluminoxane, so as to obtain polybutadiene with a syndiotactic 1,2 living structure; subsequently adding isoprene, and continuing said stereospecific polymerization, so as to obtain a polyisoprene block with a perfectly alternating 1,4-cis/3,4 structure; finally, adding butadiene once again, so as to obtain a second polybutadiene block with a syndiotactic 1,2 structure.

In accordance with a preferred embodiment of the present invention, said phosphine is selected from aromatic phosphines of the type PRₘPhₙ wherein:
m=0, 1, 2 and n=1, 2, 3
R is selected from linear or branched C₁-C₂₀, preferably C₁-C₁₅, alkyl groups; C₃-C₃₀, preferably C₄-C₁₅, cycloalkyl groups, more preferably are selected from linear or branched iso-C₂₀, preferably C₁-C₁₅; cycloalkyl groups C₃-C₃₀, preferably C₄-C₁₅, more preferably are selected from iso-propyl, tert-butyl, cyclopentyl, cyclohexyl;
Ph is a group of formula

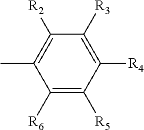

wherein R₂, R₃, R4 and R₅ are independently selected from the group consisting of H, C₁-C₆ alkyl.

In accordance with a preferred embodiment of the present invention, said monodentate aromatic phosphine can be selected from: tert-butyl diphenylphosphine, cyclohexyl-diphenylphosphine, iso-propyl-diphenylphosphine, methyl-diphenylphosphine, ethyl-diphenylphosphine, n-propyl-diphenylphosphine, dimethyl-phenylphosphine, diethyl-phenylphosphine, di-normal-propyl phenylphosphine, di-tert-butylphenylphosphine, dicyclohexyl-phenylphosphine, tri-phenylphosphine, Cyclohexyl-diphenylphosphine, iso-propyl-diphenylphosphine, tert-butyl diphenylphosphine and triphenylphosphine are preferred.

It should be pointed out that when a monodentate aromatic phosphine with a high steric hindrance is used, for example, cyclohexyl-diphenylphosphine having a “cone angle” (0) equal to 153°, iso-propyl-diphenylphosphine having a “cone angle” (0) equal to 150°, a stereoregular diblock polybutadiene is obtained, in which the polybutadiene block having a 1,2 structure and the polypentadiene block with a 1,2 structure have a higher crystallinity degree, i.e., it has a content of syndiotactic triads [(rr) %] greater than or equal to 50%, preferably between 60% and 80%, and have a melting point (Tₘ) greater than or equal to 70° C., preferably between 95° C. and 140° C., in the case in which a monodentate aromatic phosphine with a lower steric hindrance is used, for example, methyl-diphenylphosphine having a cone angle (θ) equal to 136°, ethyl-diphenylphosphine having a cone angle (θ) equal to 141°, n-propyl-diphenylphosphine having a cone angle (θ) equal to 142°, dimethyl-phenylphosphine having a cone angle (θ) equal to 127°, diethyl-phenylphosphine having a cone angle (θ) equal to 136°, a stereoregular copolymer is obtained in which the polybutadiene block having a 1,2 structure has a lower degree of crystallinity, i.e., they have a content of syndiotactic triads [(rr) %] lower than or equal to 50%, preferably between 30% and 40%, and have a melting point (Tₘ) between 50° C. and 70° C.

The cone angle (θ) is the one indicated by Tolman C. A. in “Chemical Reviews” (1977), Vol. 77, pages 313-348.

In accordance with a preferred embodiment of the present invention, said catalytic system can comprise at least one co-catalyst selected from organic compounds of an element M′ different from carbon, said element M′ being selected from elements belonging to groups 2, 12, 13 or 14 of the Periodic Table of the Elements, preferably from: boron, aluminum, zinc, magnesium, gallium, tin, even more preferably from aluminum, boron.

In accordance with a further preferred embodiment of the present invention, said co-catalyst can be selected from aluminum alkyls having general formula:

Al(X′)ₙ(R₆)₃₋ₙ

wherein X′ represents a halogen atom selected from chlorine, bromine, iodine, fluorine; R₆ is selected from linear or branched C₁-C₂₀ alkyl groups, cycloalkyl groups, aryl groups, said groups being optionally substituted with one or more silicon or germanium atoms; and n is an integer between 0 and 2.

In accordance with a further preferred embodiment of the present invention, said co-catalyst can be selected from organo-oxygenated compounds of an element M′ different from carbon belonging to groups 13 or 14 of the Periodic Table of the Elements, preferably organo-oxygenated compounds of aluminum, gallium or tin. Said organo-oxygenated compounds can be defined as organic compounds of M′, wherein this latter is bound to at least one oxygen atom and to at least one organic group consisting of an alkyl group having from 1 to 6 carbon atoms, preferably methyl.

In accordance with a further preferred embodiment of the present invention, said co-catalyst can be selected from compounds or mixtures of organometallic compounds of an element M′ different from carbon capable of reacting with the product of the reaction between CoCl₂ and phosphine, extracting from these a mono- or polyvalent anion to form, on the one hand, at least one neutral compound, and on the other, an ionic compound consisting of a cation containing the metal (Co) coordinated by the ligand, and of a non-coordinating organic anion containing the metal M′, the negative charge of which is delocalized on a multicentric structure.

It should be pointed out that, for the purpose of the present invention and of the appended claims, the term “Periodic Table of the Elements” refers to the “IUPAC Periodic Table of the Elements”, version dated 22 Jun. 2007.

For the purpose of the present description and of the appended claims the phrase “room temperature” is meant as a temperature between 20° C. and 25° C.

Specific examples of aluminum alkyls having general formula (III) particularly useful for the purpose of the present invention are: tri-methyl-aluminum, tri-(2,3,3-tri-methyl-butyl)-aluminum, tri-(2,3-di-methyl-hexyl)-aluminum, tri-(2,3-di-methyl-butyl)-aluminum, tri-(2,3-di-methyl-pentyl)-aluminum, tri-(2,3-di-methyl-heptyl)-aluminum, tri-(2-methyl-3-ethyl-pentyl)-aluminum, tri-(2-methyl-3-ethyl-hexyl)-aluminum, tri-(2-methyl-3-ethyl-heptyl)-aluminum, tri-(2-methyl-3-propyl-hexyl)-aluminum, tri-ethyl-aluminum, tri-(2-ethyl-3-methyl-butyl)-aluminum, tri-(2-ethyl-3-methyl-pentyl)-aluminum, tri-(2,3-di-ethyl-pentyl-aluminum), tri-n-propyl-aluminum, tri-iso-propyl-aluminum, tri-(2-propyl-3-methyl-butyl)-aluminum, tri-(2-iso-propyl-3-methyl-butyl)-aluminum, tri-n-butyl-aluminum, tri-iso-butyl-aluminum (TIBA), tri-tert-butyl-aluminum, tri-(2-iso-butyl-3-methyl-pentyl)-aluminum, tri-(2,3,3-tri-methyl-pentyl)-aluminum, tri-(2,3,3-tri-methyl-hexyl)-aluminum, tri-(2-ethyl-3,3-di-methyl-butyl)-aluminum, tri-(2-ethyl-3,3-di-methyl-pentyl)-aluminum, tri-(2-iso-propyl-3,3-dimethyl-butyl)-aluminum, tri-(2-tri-methylsilyl-propyl)-aluminum, tri-2-methyl-3-phenyl-butyl)-aluminum, tri-(2-ethyl-3-phenyl-butyl)-aluminum, tri-(2,3-di-methyl-3-phenyl-butyl)-aluminum, tri-(2-phenyl-propyl)-aluminum, tri-[2-(4-fluoro-phenyl)-propyl]-aluminum, tri-[2-(4-chloro-phenyl)-propyl]-aluminum, tri-[2-(3-iso-propyl-phenyl-tri-(2-phenyl-butyl)-aluminum, tri-(3-methyl-2-phenyl-butyl)-aluminum, tri-(2-phenyl-pentyl)-aluminum, tri-[2-(penta-fluoro-phenyl)-propyl]-aluminum, tri-(2,2-diphenyl-ethyl]-aluminum, tri-(2-phenyl-methyl-propyl]-aluminum, tri-pentyl-aluminum, tri-hexyl-aluminum, tri-cyclohexyl-aluminum, tri-octyl-aluminum, di-ethyl-aluminum hydride, di-n-propyl-aluminum hydride, di-n-butyl-aluminum hydride, di-iso-butyl-aluminum hydride (DIBAH), di-hexyl-aluminum hydride, di-iso-hexyl-aluminum hydride, di-octyl-aluminum hydride, di-iso-octyl-aluminum hydride, ethyl-aluminum di-hydride, n-propyl-aluminum di-hydride, iso-butyl-aluminum di-hydride, di-ethyl-aluminum chloride (DEAC), mono-ethyl-aluminum dichloride (EADC), di-methyl-aluminum chloride, di-iso-butyl-aluminum chloride, iso-butyl-aluminum dichloride, ethylaluminum-sesquichloride (EASC), as well as the corresponding compounds in which one of the hydrocarbon substituents is substituted by a hydrogen atom and those in which one or two of the hydrocarbon substituents are substituted with an iso-butyl group. Di-ethyl-aluminum chloride (DEAC), mono-ethyl-aluminum dichloride (EADC), ethylaluminumsesquichloride (EASC), are particularly preferred.

Preferably, when used for the formation of a catalytic polymerization system in accordance with the present invention, the aluminum alkyls having general formula (III) can be placed in contact with the product of the reaction between CoCl₂ and phosphine in proportions such that the molar ratio between the cobalt present and the aluminum present in the aluminum alkyls having general formula (III) can be between 5 and 5000, preferably between 10 and 1000. The sequence with which the product of the reaction between CoCl₂ and phosphine and the aluminum alkyl having general formula (III) are placed in contact with each other is not particularly critical.

Further details relating to aluminum alkyls having general formula (II) can be found in WO 2011/061151.

In accordance with a particularly preferred embodiment, said organo-oxygenated compounds can be selected from aluminoxanes having general formula:

(R₇)₂—Al—OR—[—Al(R₈)—O-]ₚ-Al—(R₉)₂

wherein R₇, R₈ and R₉, the same as or different from each other, represent a hydrogen atom, a halogen atom, such as chlorine, bromine, iodine, fluorine; or are selected from linear or branched C₁-C₂₀ alkyl groups, cycloalkyl groups, aryl groups, said groups being optionally substituted with one or more silicon or germanium atoms; and p is an integer between 0 and 1000.

As is known, aluminoxanes are compounds containing Al—O—Al bonds, with a variable O/Al ratio, which can be obtained according to processes known in the art, such as by reaction, under controlled conditions, of an aluminum alkyl, or of an aluminum alkyl halide, with water or with other compounds containing predetermined quantities of available water, such as in the case of the reaction of aluminum trimethyl with aluminum sulfate hexahydrate, copper sulfate pentahydrate, or iron sulfate pentahydrate.

Said aluminoxanes, and in particular methylaluminoxane (MAO), are compounds that can be obtained by means of known organometallic chemical processes, for example, by adding aluminum trimethyl to a suspension in hexane of aluminum sulfate hydrate.

Preferably, when used for the formation of a catalytic polymerization system in accordance with the present invention, aluminoxanes having general formula (IV) can be placed in contact with the product of the reaction between CoCl₂ and a phosphine in proportions such that the molar ratio between the aluminum (Al) present in the aluminoxane and the cobalt present is between 10 and 10000, preferably between 20 and 1000.

Specific examples of aluminoxanes particularly useful for the purpose of the present invention are: methylaluminoxane (MAO), ethyl-aluminoxane, n-butyl-aluminoxane, tetra-iso-butyl-aluminoxane (TIBAO), tert-butyl-aluminoxane, tetra-(2,4,4-tri-methyl-pentyl)-aluminoxane (TIOAO), tetra-(2,3-di-methyl-butyl)-aluminoxane (TDMBAO), tetra-(2,3,3-tri-methyl-butyl)-aluminoxane (TTMBAO). Methylaluminoxane (MAO) is particularly preferred.

Further details relating to aluminoxanes having general formula can be found in WO 2011/061151.

The amount of cobalt that can be used in the process of the present invention varies according to the polymerization process to be carried out. Said amount is in any case such as to obtain a molar ratio between the cobalt and the metal present in the co-catalyst, e.g., aluminum in the case in which the co-catalyst is selected from aluminum alkyls or from aluminoxanes, within the values indicated above.

In accordance with a preferred embodiment of the present invention, said process can be carried out in the presence of an inert organic solvent selected, for example, from: saturated aliphatic hydrocarbons, such as butane, pentane, hexane, heptane, or their mixtures; saturated cycloaliphatic hydrocarbons, such as cyclopentane, cyclohexane, or their mixtures; mono-olefins, such as 1-butene, 2-butene, or their mixtures; aromatic hydrocarbons, such as benzene, toluene, xylene, or their mixtures; halogenated hydrocarbons, such as methylene chloride, chloroform, carbon tetrachloride, trichloroethylene, perchloroethylene, 1,2-dichloroethane, chloro-benzene, bromobenzene, chlorotoluene, or their mixtures. Preferably, said solvent is selected from saturated aliphatic hydrocarbons.

In accordance with a preferred embodiment of the present invention, the concentration of 1,3-butadiene, of isoprene and of pentadiene to be polymerized in said inert organic solvent can be between 5% by weight and 50% by weight, preferably between 10% by weight and 20% by weight, with respect to the total weight of the mixture of 1,3-butadiene, isoprene, pentadiene and inert organic solvent.

In accordance with a preferred embodiment of the present invention, said process can be carried out at a temperature between −70° C. and +120° C., preferably between −20° C. and +100° C.

With regard to pressure, it is preferable to operate at the pressure of the components of the mixture to be polymerized, said pressure differing according to the polymerization temperature used.

The aforesaid process can be carried out either batchwise or continuously.

For a better understanding of the present invention and for its implementation, some illustrative and non-limiting examples thereof are provided below.

Characteristics and advantages of the invention will be more apparent from the description of preferred embodiments, illustrated by way of example in the accompanying drawings; wherein:

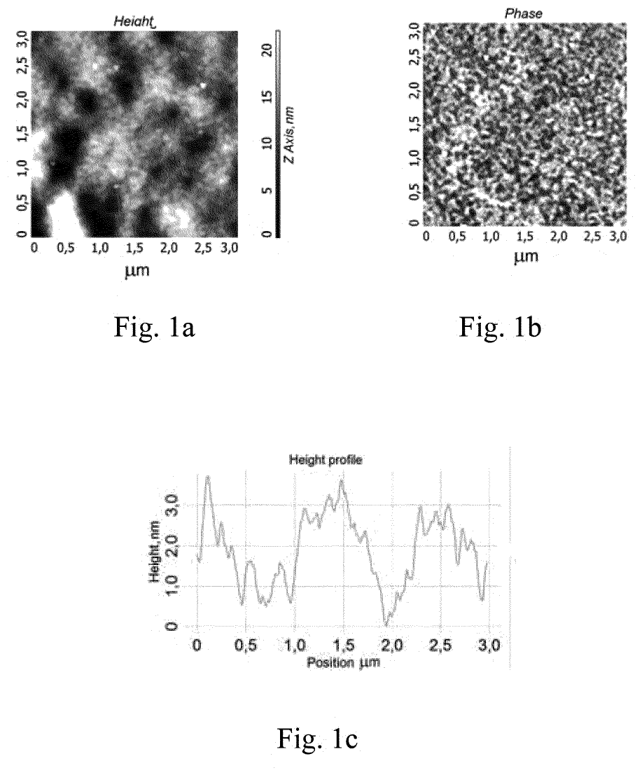

FIGS. 1a/1b/1c show AFM images of the butadiene/isoprene stereoblock copolymer of example 7;

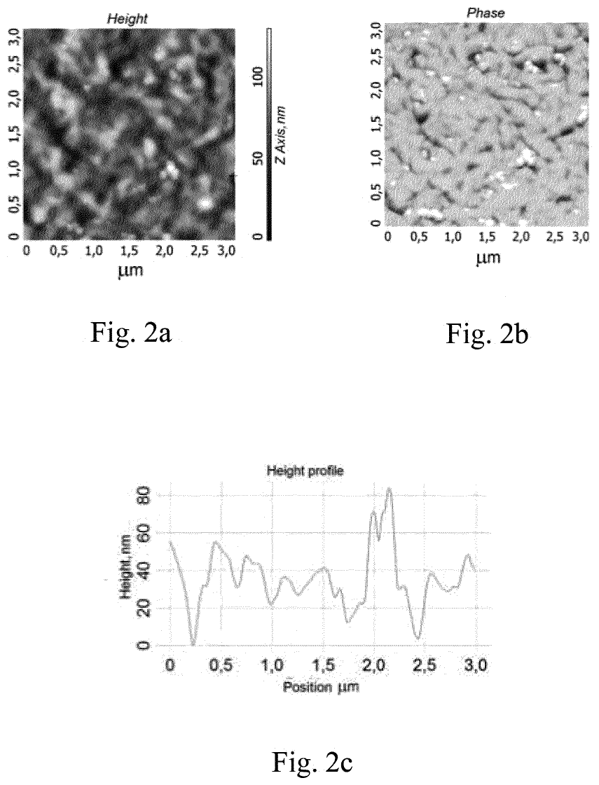

FIGS. 2a/2b/2c show AFM images of a mechanical mixture consisting of syndiotactic 1,2 polybutadiene/alternating cis-1,4/3,4 polyisoprene;

FIG. 3 shows ¹³C-NMR spectra of polybutadienes with different degrees of syndiotacticity;

FIG. 4 shows ¹H NMR spectra of isoprene/butadiene stereoblock copolymers;

FIG. 5 shows ¹³C NMR spectra of the syndiotactic 1,2 polypentadiene of example 2;

FIG. 6 shows ¹H NMR spectra of the isoprene-pentadiene stereoblock copolymer of example 13;

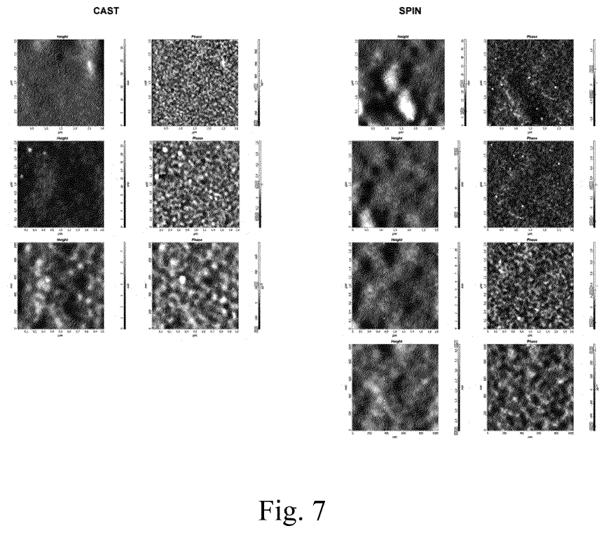

FIG. 7 shows AFM images of the butadiene/isoprene/butadiene terpolymer of Ex. 16;

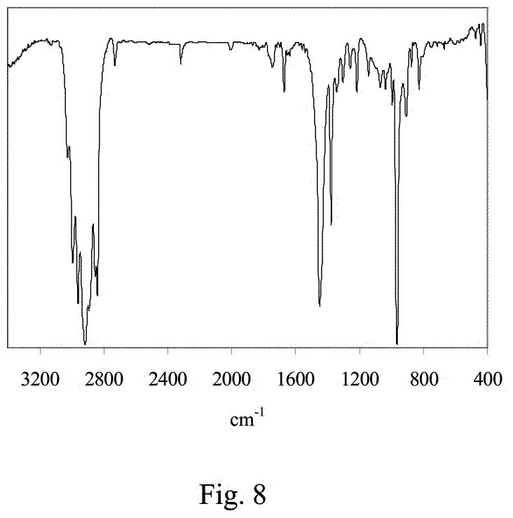

FIG. 8 shows FT-IR of the polypentadiene of example 2;

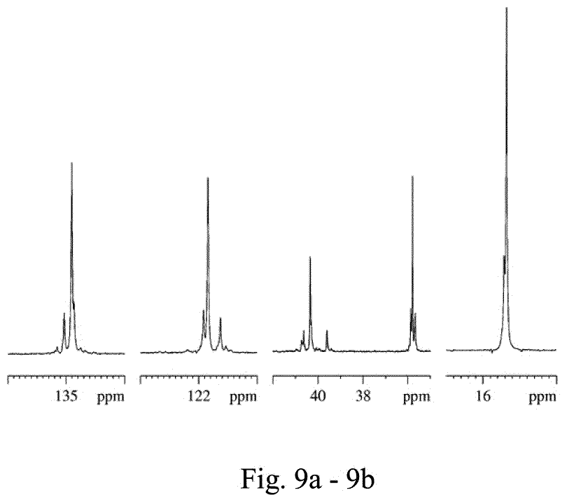

FIG. 9a shows ¹H NMR of the polypentadiene of example 2;

FIG. 9b shows ¹³C NMR of the polypentadiene of example 2;

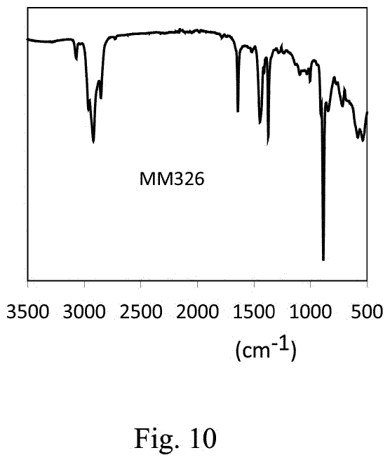

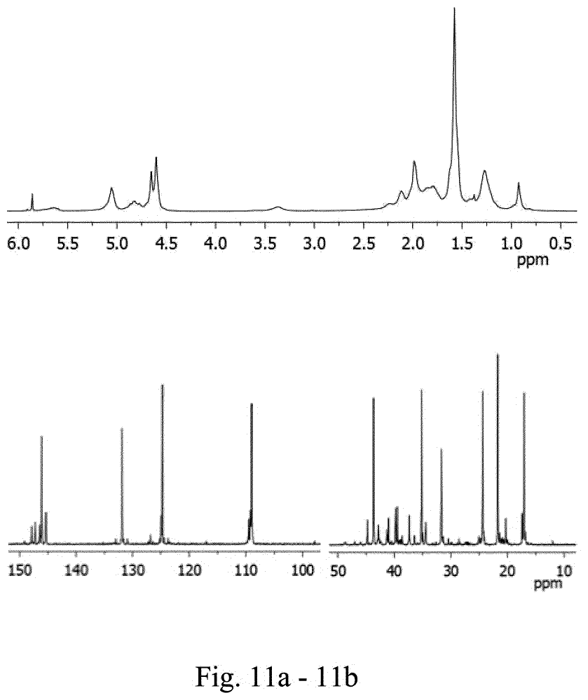

FIG. 10 shows FT-IR of the polyisoprene of example 3;

FIG. 11a shows ¹H NMR of the polyisoprene of example 3;

FIG. 11b shows ¹³C NMR of the polyisoprene of example 3;

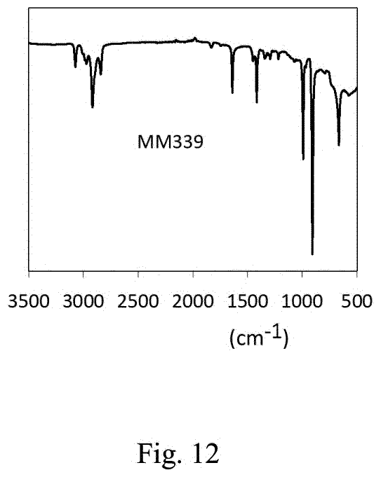

FIG. 12 shows FT-IR of the polybutadiene of example 4;

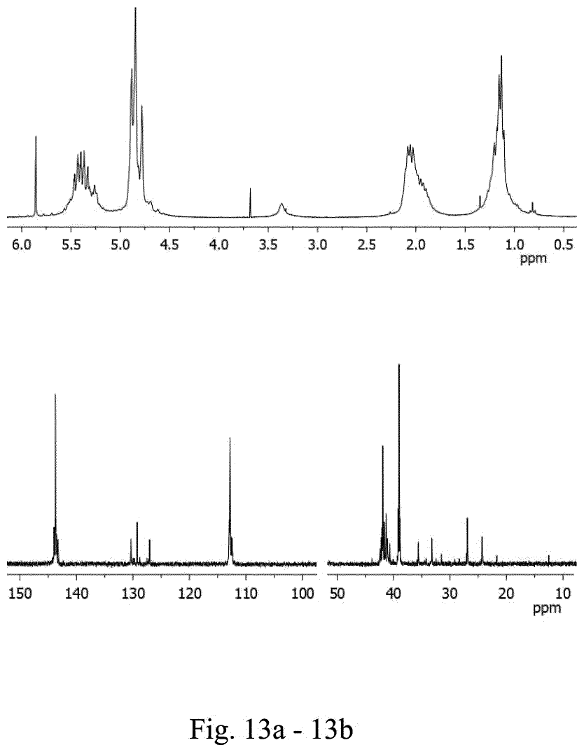

FIG. 13a shows ¹H NMR of the polybutadiene of example 4;

FIG. 13b shows ¹³C NMR of the polybutadiene of example 4;

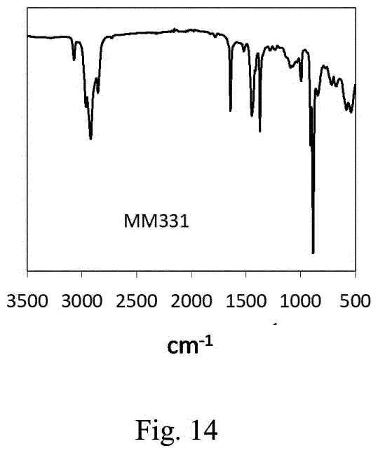

FIG. 14 shows FT-IR of the copolymer of example 5;

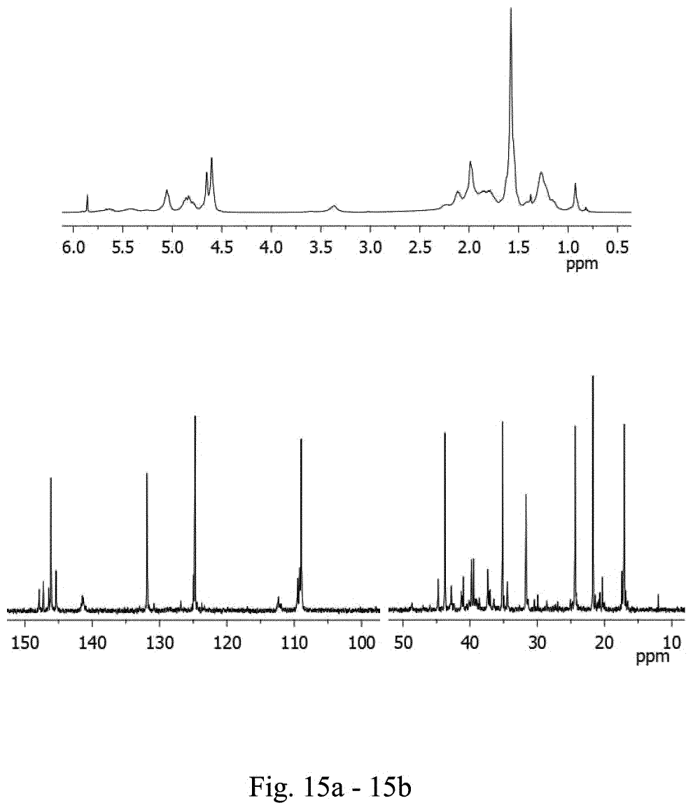

FIG. 15a shows ¹H NMR of the copolymer of example 5;

FIG. 15b shows ¹³C NMR of the copolymer of example 5;

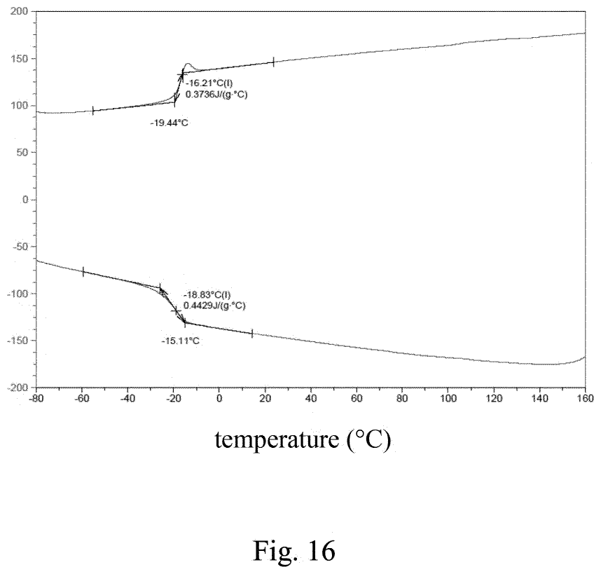

FIG. 16 shows DSC of the copolymer of example 5;

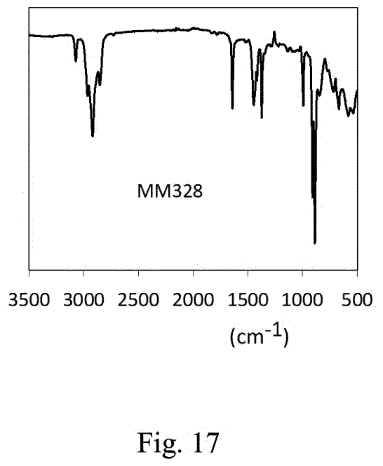

FIG. 17 shows FT-IR of the copolymer of example 6;

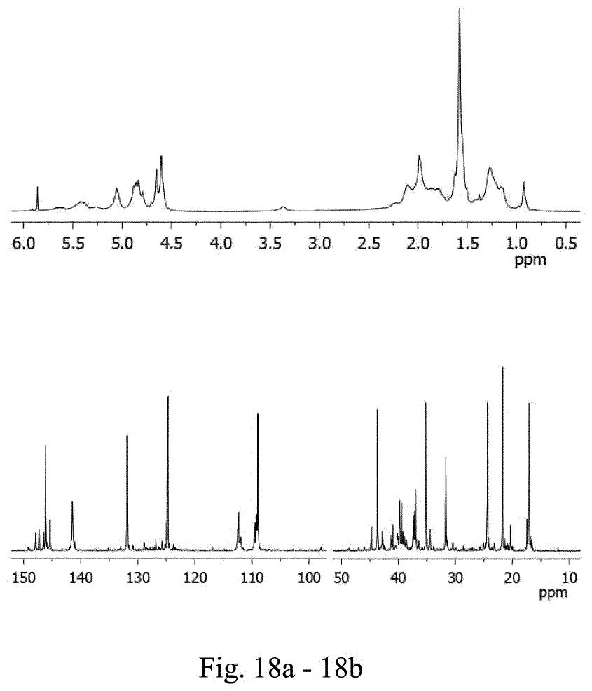

FIG. 18a shows ¹H NMR of the copolymer of example 6;

FIG. 18b shows ¹³C NMR of the copolymer of example 6;

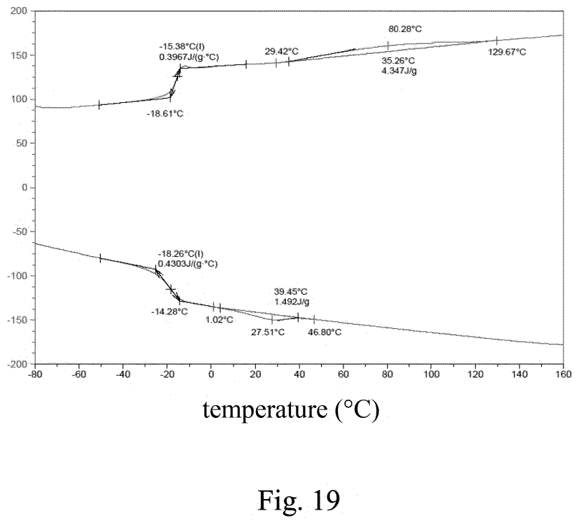

FIG. 19 shows DSC of the copolymer of example 6;

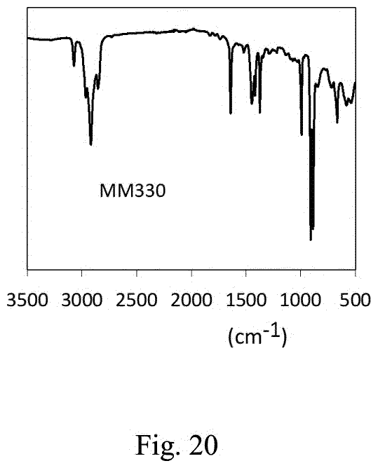

FIG. 20 shows FT-IR of the copolymer of example 7;

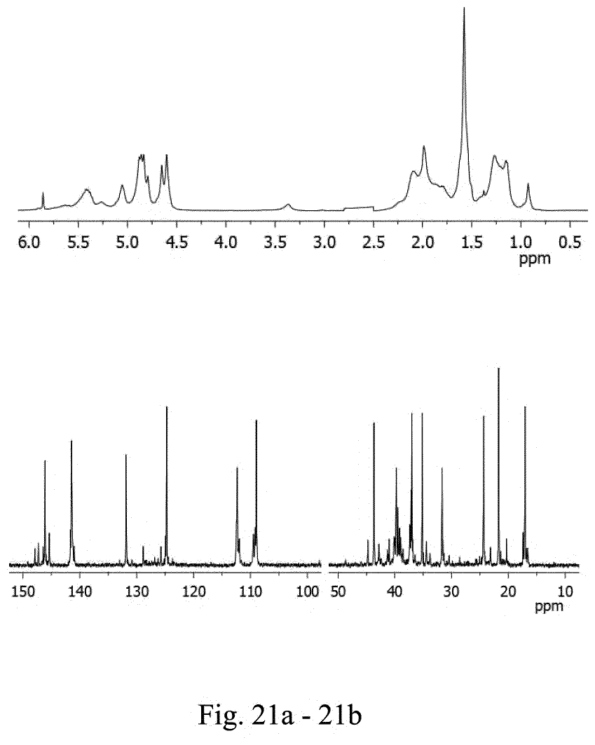

FIG. 21a shows ¹H NMR of the copolymer of example 7;

FIG. 21b shows ¹³C NMR of the copolymer of example 7;

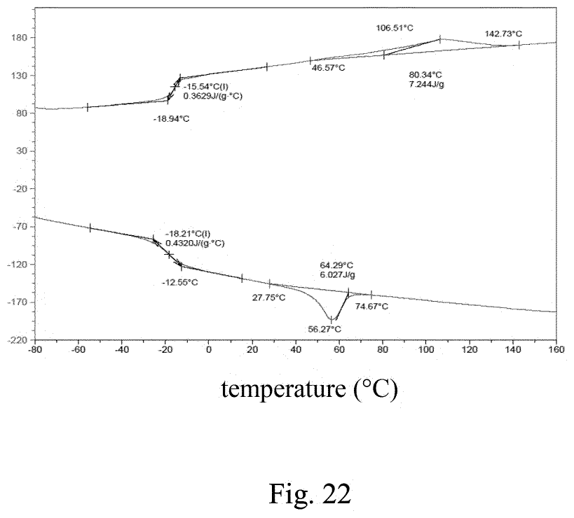

FIG. 22 shows DSC of the copolymer of example 7;

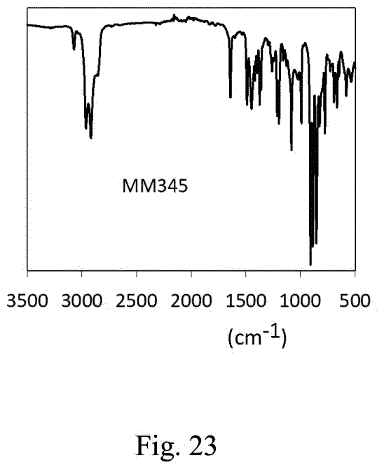

FIG. 23 shows FT-R of the copolymer of example 8;

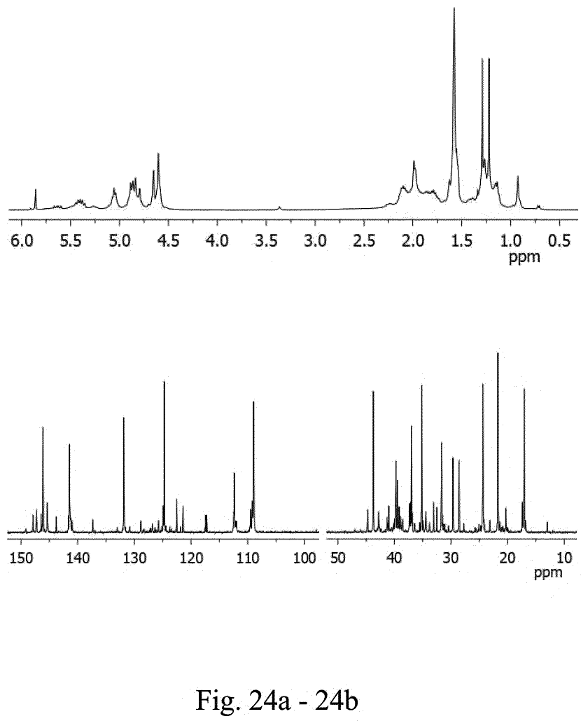

FIG. 24a shows ¹H NMR of the copolymer of example 8;

FIG. 24b shows ¹³C NMR of the copolymer of example 8;

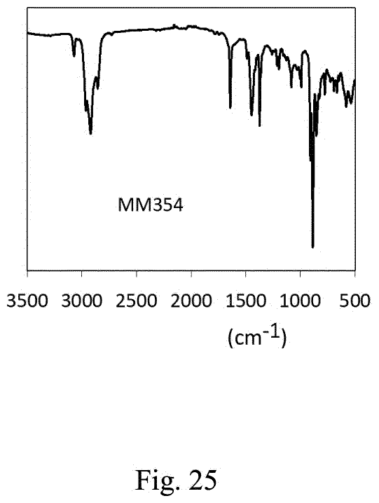

FIG. 25 shows FT-IR of the copolymer of example 9;

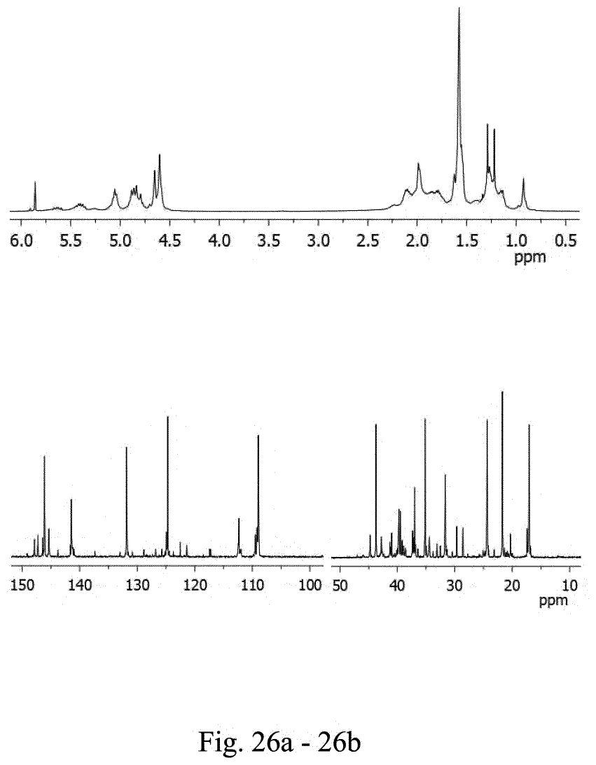

FIG. 26a shows ¹H NMR of the copolymer of example 9;

FIG. 26b shows ¹³C NMR of the copolymer of example 9;

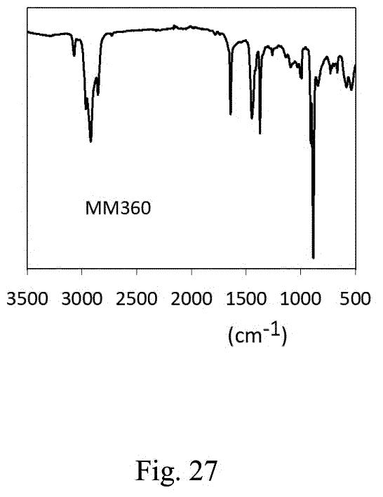

FIG. 27 shows FT-IR of the copolymer of example 10;

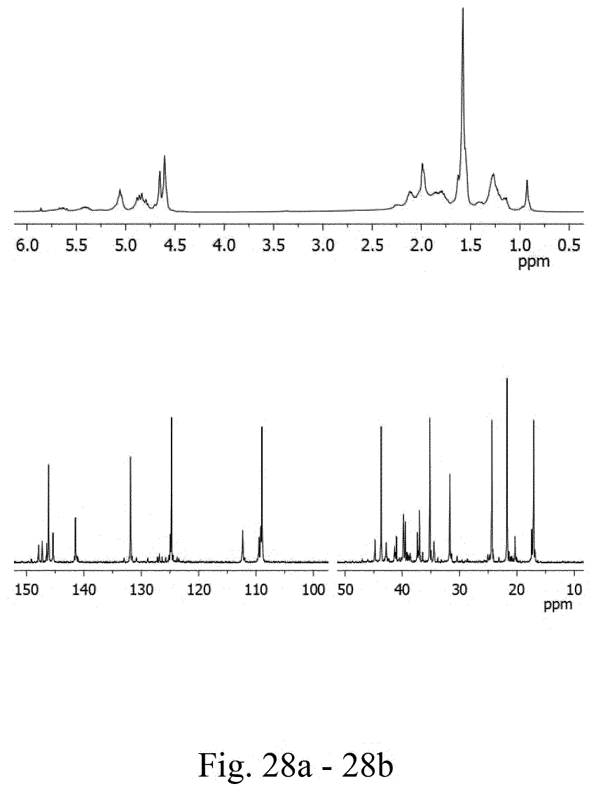

FIG. 28a shows ¹H NMR of the copolymer of example 10;

FIG. 28b shows ¹³C NMR of the copolymer of example 10;

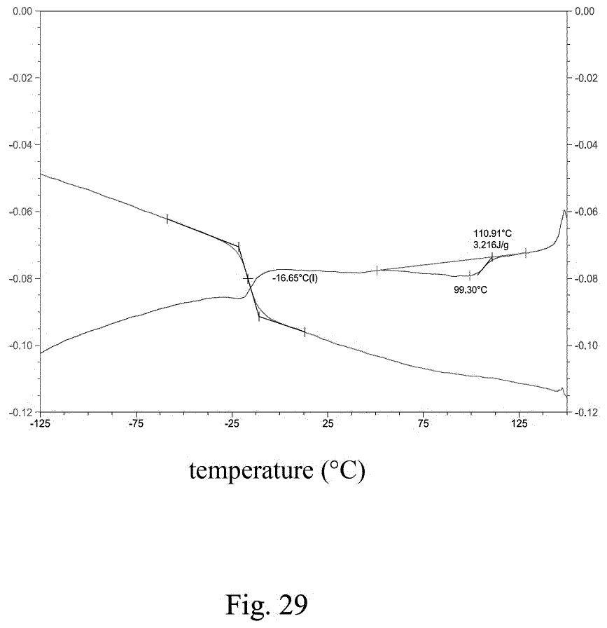

FIG. 29 shows DSC of the copolymer of example 10;

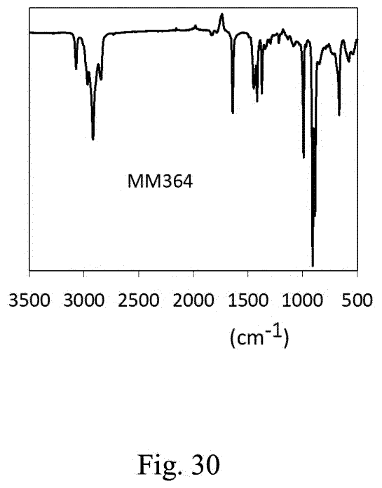

FIG. 30 shows FT-IR of the copolymer of example 11;

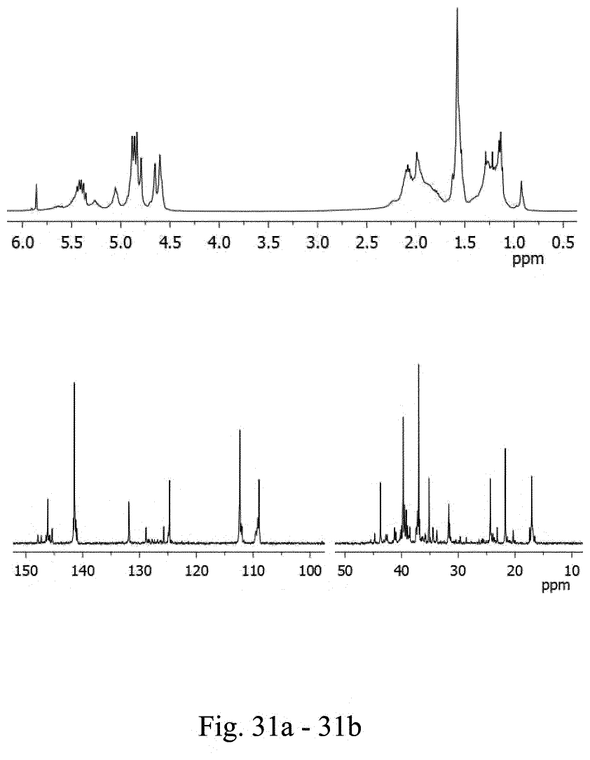

FIG. 31a shows ¹H NMR of the copolymer of example 11;

FIG. 31b shows ¹³C NMR of the copolymer of example 11;

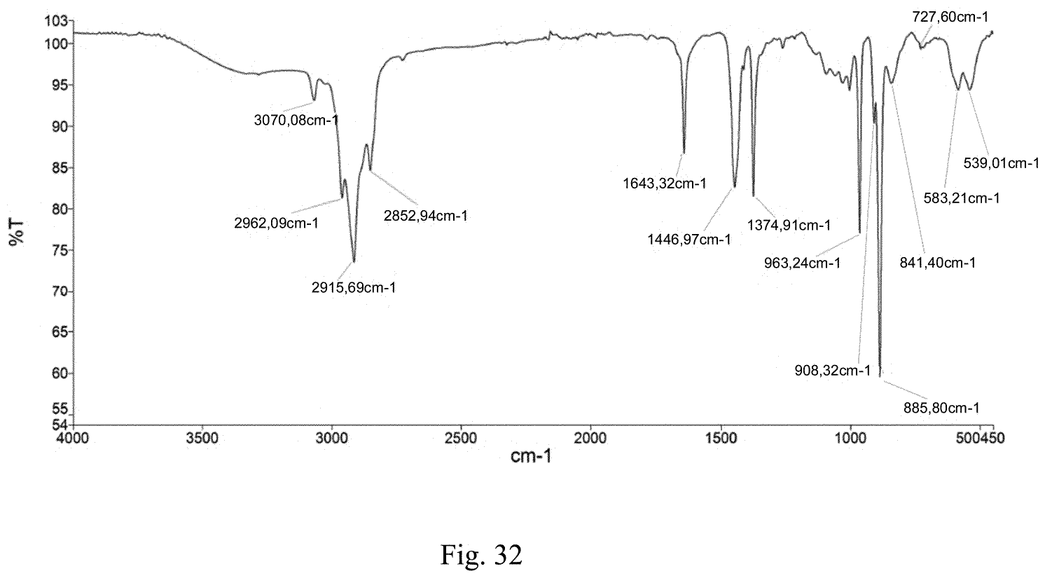

FIG. 32 shows FT-IR of the copolymer of example 12;

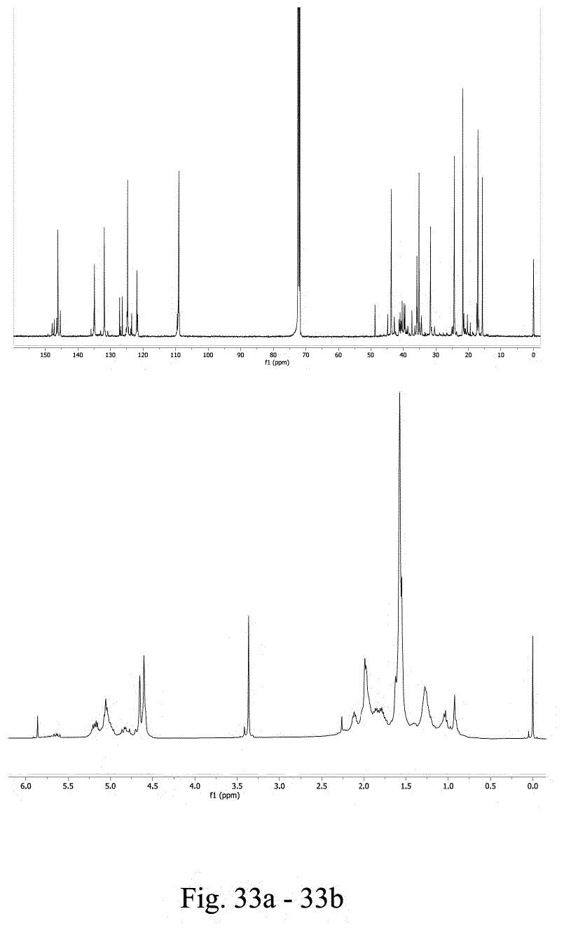

FIG. 33a shows ¹H NMR of the copolymer of example 12;

FIG. 33b shows ¹³C NMR of the copolymer of example 12;

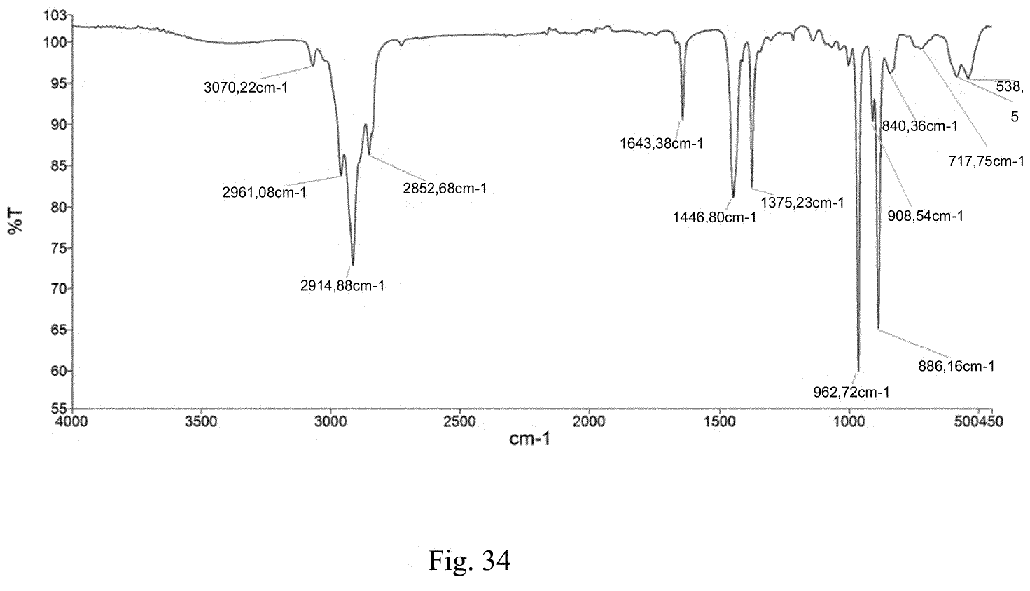

FIG. 34 shows FT-IR of the copolymer of example 13;

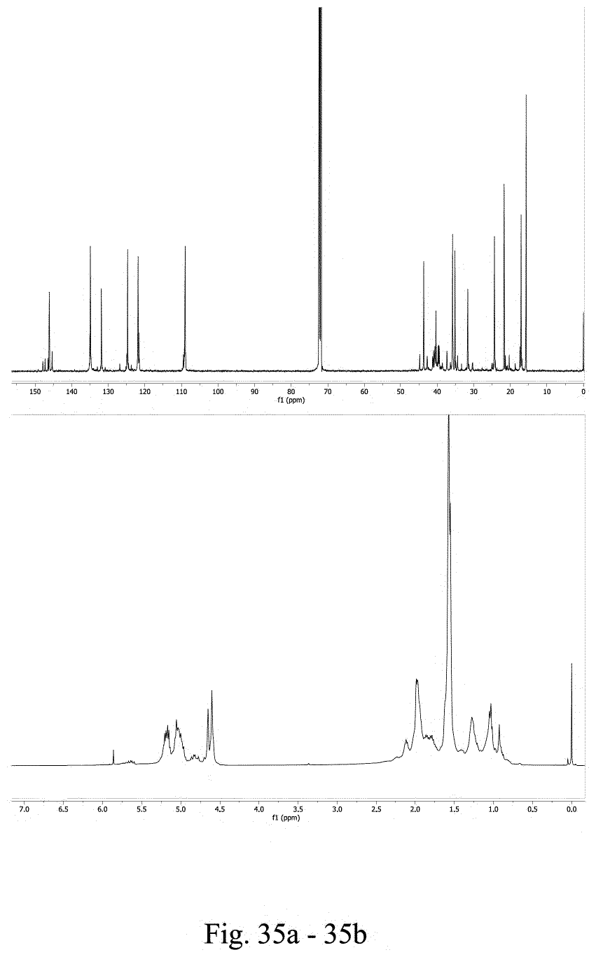

FIG. 35a shows ¹H NMR of the copolymer of example 13;

FIG. 35b shows ¹³C NMR of the copolymer of example 13;

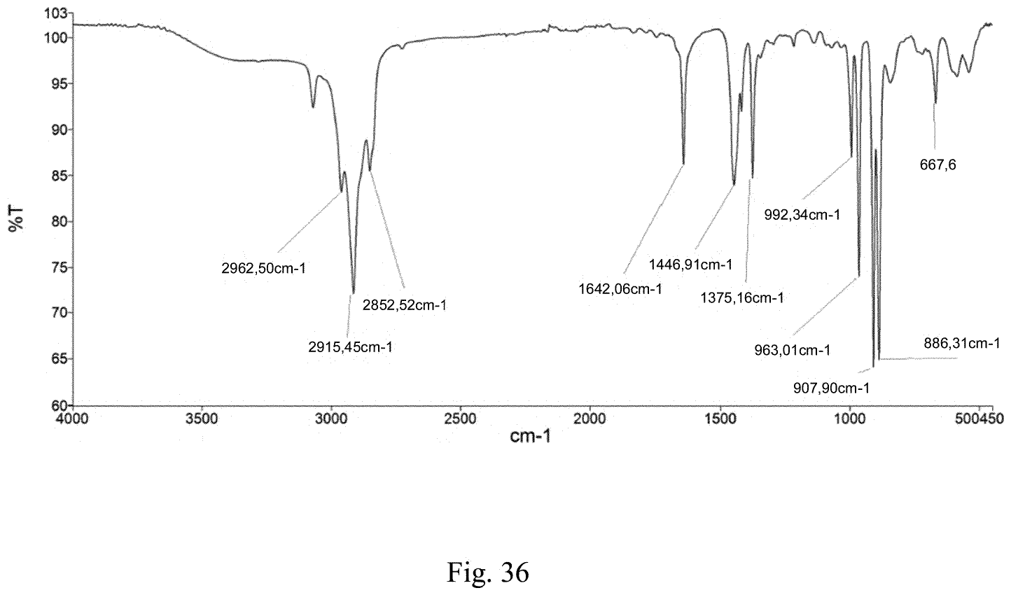

FIG. 36 shows FT-IR of the copolymer of example 14;

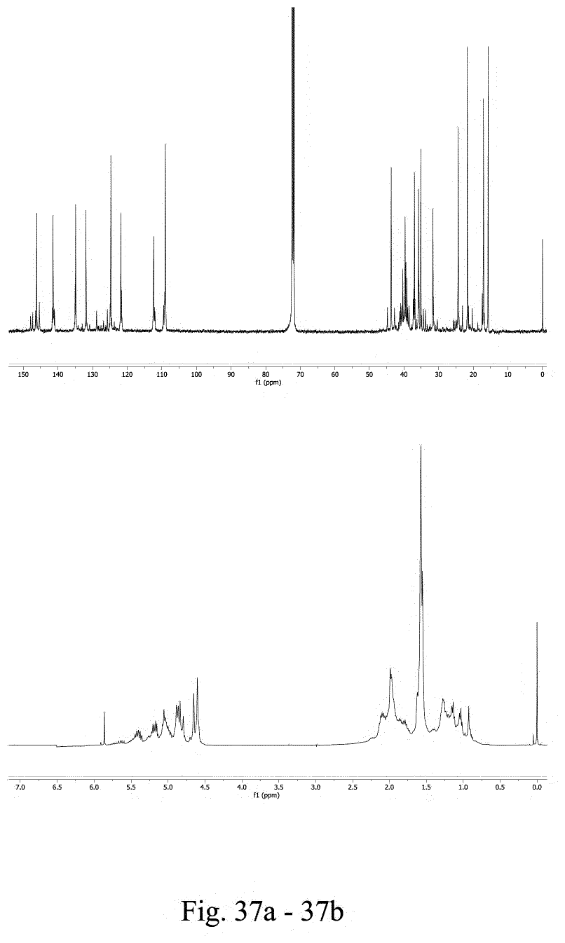

FIG. 37a shows ¹H NMR of the copolymer of example 14;

FIG. 37b shows ¹³C NMR of the copolymer of example 14;

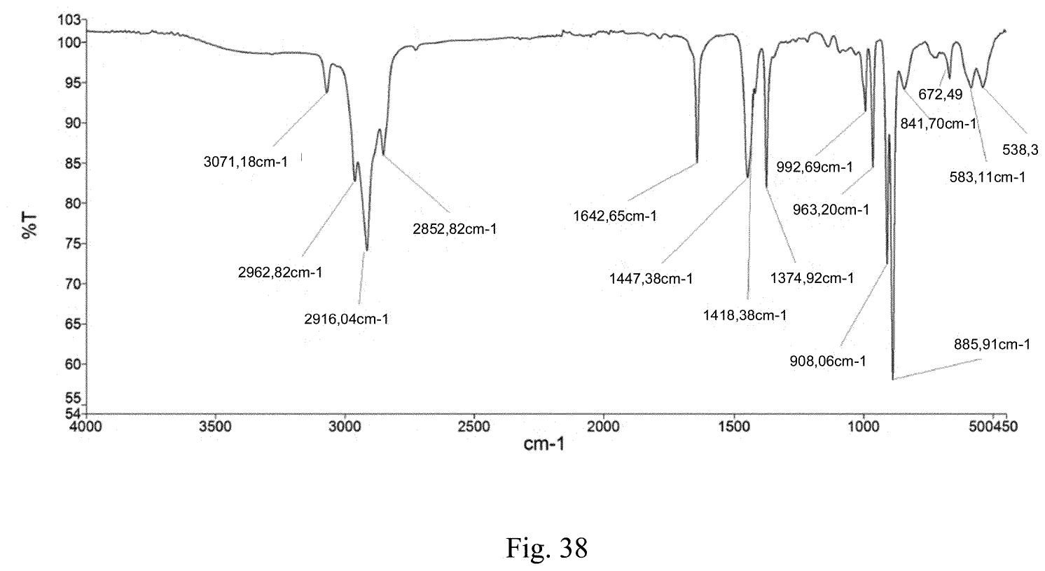

FIG. 38 shows FT-IR of the copolymer of example 15;

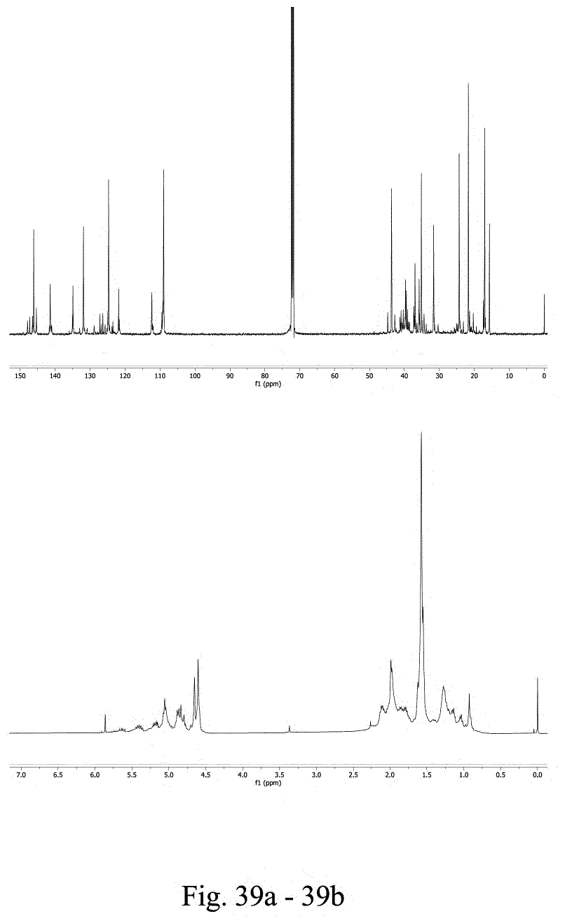

FIG. 39a shows ¹H NMR of the copolymer of example 15;

FIG. 39b shows ¹³C NMR of the copolymer of example 15;

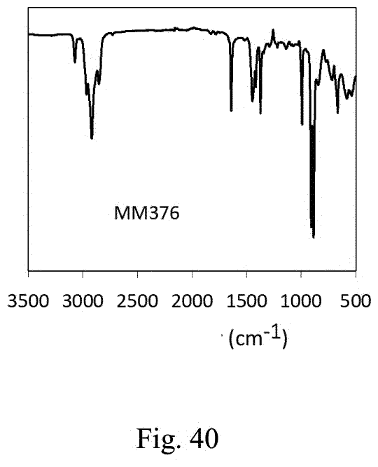

FIG. 40 shows FT-IR of the copolymer of example 16;

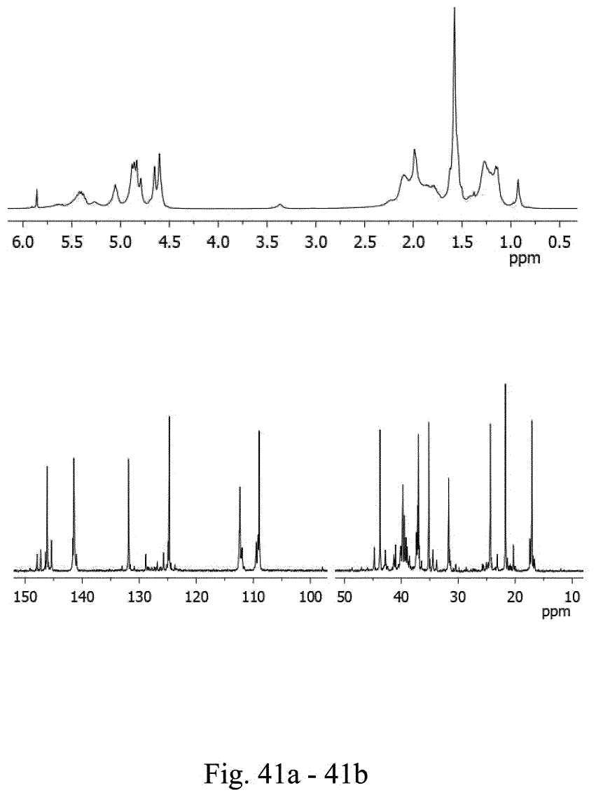

FIG. 41a shows ¹H NMR of the copolymer of example 16;

FIG. 41b shows ¹³C NMR of the copolymer of example 16;

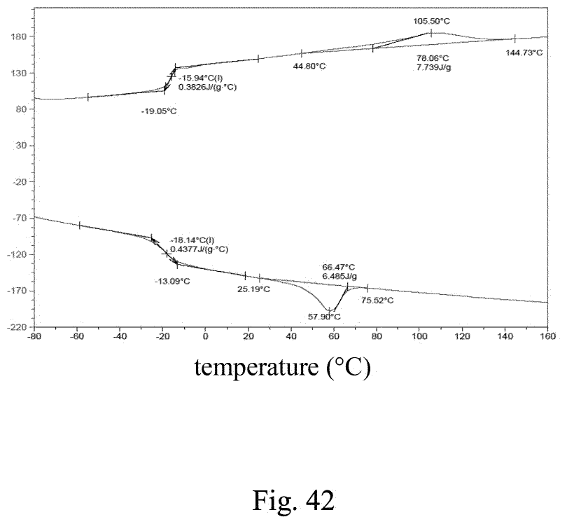

FIG. 42 shows DSC of the copolymer of example 16;

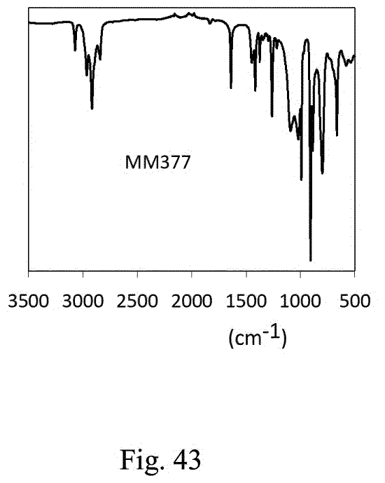

FIG. 43 shows FT-IR of the copolymer of example 17;

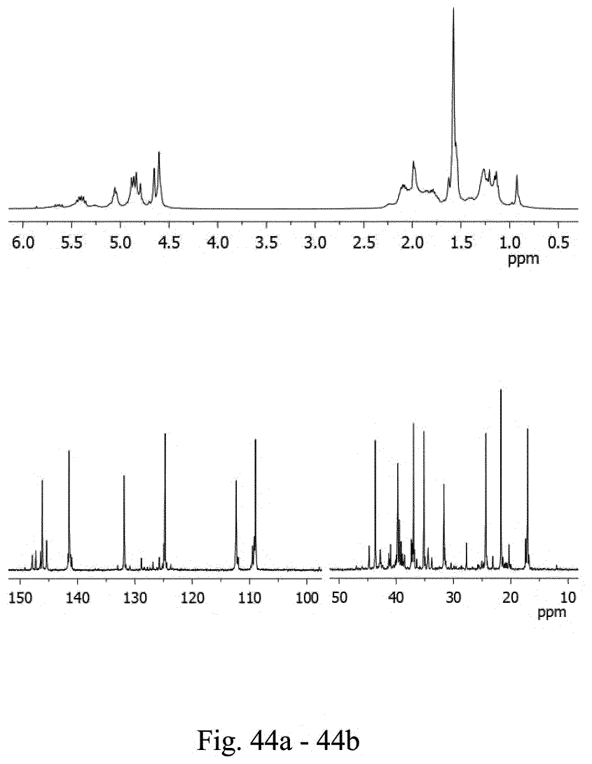

FIG. 44a shows ¹H NMR of the copolymer of example 17;

FIG. 44b shows ¹³C NMR of the copolymer of example 17;

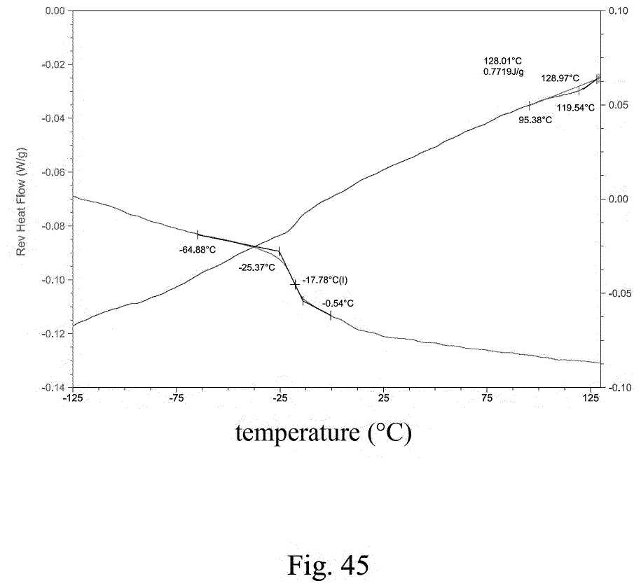

FIG. 45 shows DSC of the copolymer of example 17;

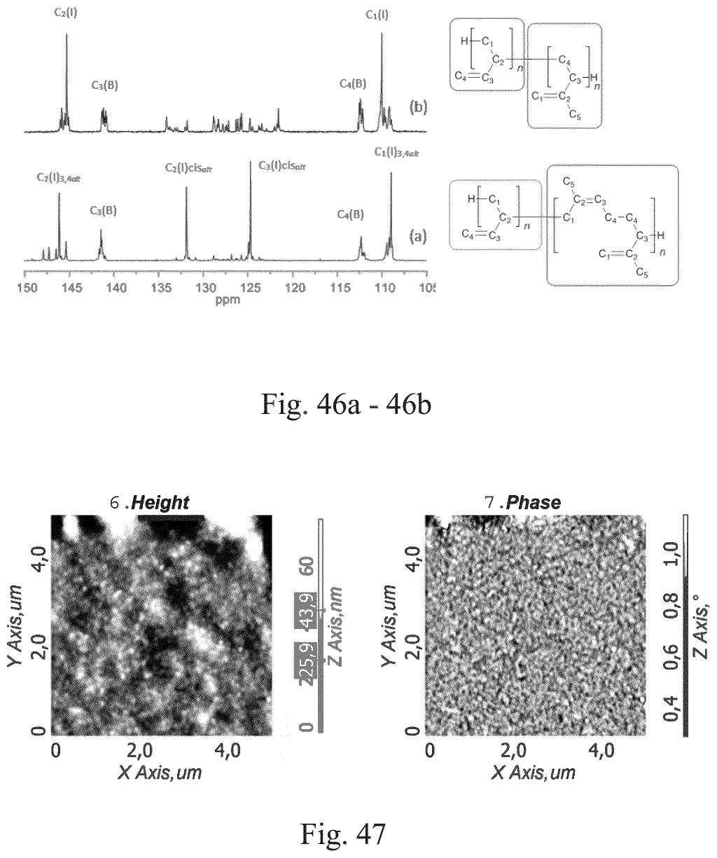

FIGS. 46a and 46b show ¹³C NMR of the copolymer of Example 6 according to the invention and the copolymer of Example 18 of US 2020/0109229 A1: and

FIG. 47 shows AFM images of a mixture of the copolymer of Example 6 according to the invention and natural rubber (example 18).

### EXAMPLES

Reagents and Materials

The reagents and materials used in the subsequent examples of the invention are listed below, together with their optional pretreatments and their manufacturer:
cobalt dichloride (CoCl₂) (Strem Chemicals): used as is;
pentane (Aldrich): pure, ≥99.5%, distilled on sodium (Na) in inert atmosphere;
1,3-butadiene (Air Liquide): pure, ≥99.5%, evaporated from the container before each production, dried by passing through a column packed with molecular sieves and condensed inside the reactor pre-cooled to −20° C.;
isoprene (Aldrich): pure, ≥99.5%, refluxed with calcium hydride (CaH₂) for around 2 h, then distilled trap-to-trap and kept refrigerated in an inert atmosphere;
(E)-1,3-pentadiene (Aldrich): pure, 99%, refluxed with calcium hydride (CaH₂) for around 2 h, then distilled trap-to-trap and kept refrigerated in an inert atmosphere;
toluene (Aldrich): pure, ≥99.5%, distilled on sodium (Na) in an inert atmosphere;
methylene chloride (Sigma-Aldrich, purification grade)
methylaluminoxane (MAO) (toluene solution at 10% by weight) (Aldrich): used as is;
methyldiphenylphosphine (Strem, 99% pure);
dimethylphenylphosphine (Strem, 99% pure);
ethyldiphenylphosphine (Aldrich, 98% pure);
diethylphenylphosphine (Aldrich, 96% pure);
normal-propyldiphenylphosphine (Aldrich, 98% pure);
iso-propyldiphenylphosphine (Aldrich, 97% pure);
tert-butyldiphenylphosphine (Strem);
allyldiphenylphosphine (Aldrich, 95% pure);
diallylphenylphosphine (Aldrich, 95% pure);
cyclohexyldiphenylphosphine (Strem, 98% pure);
dicyclohexylphenylphosphine (Aldrich, 95% pure);
deuterated tetrachloroethane (C₂D₂Cl₄) (Acros): used as is;
deuterated chloroform (CDCl₃) (Acros): used as is.

Analysis and Characterization Methods

¹³C-NMR and ¹H-NMR Spectra

The ¹³C-NMR and ¹H-NMR spectra were recorded by means of a nuclear magnetic resonance spectrometer mod. Bruker Avance 400, using deuterated tetrachloroethane (C₂D₂Cl₄) at 103° C., and hexamethyldisiloxane (HDMS) as internal standard, or using deuterated chloroform (CDCl₃), at 25° C., and tetramethylsilane (TMS) as internal standard. For this purpose, polymeric solutions having concentrations equal to 10% by weight with respect to the total weight of the polymeric solution were used.

The microstructure of the stereoblock copolymers and terpolymers (i.e., content of isoprene, butadiene and pentadiene units, content of cis-1,4 and 3,4 units of the isoprene block, content of 1,2 units (%) and content of syndiotactic triads [(rr) (%) of the butadiene block and of the pentadiene block], was determined by analysis of the aforesaid spectra based on the indications provided in the literature by Mochel, V. D., in “Journal of Polymer Science Part A-1: Polymer Chemistry” (1972), Vol. 10, Issue 4, pages 1009-1018, for polybutadiene; and by Sato, H., et al., in “Journal of Polymer Science: Polymer Chemistry Edition” (1979), Vol. 17, Issue 11, pages 3551-3558 for polyisoprene, by a) Beebe, D. H.; Gordon, C. E.; Thudium, R. N.; Throckmorton, M. C.; Hanlon, T. L. J. Polym. Sci: Polym. Chem. And. 1978, 16, 2285; b) Ciampelli, F.; Lachi, M. P.; Tacchi Venturi, M.; Porri, L. Eur. Polym. J. 1967, 3, 353 and G. Ricci, T. Motta, A. Boglia, E. Alberti, L. Zetta, F. Bertini, P. Arosio, A. Famulari, S. V. Meille “Synthesis, characterization and crystalline structure of syndiotactic 1,2 polypentadiene: the trans polymer.” Macromolecules 2005, 38, 8345-8352 for polypentadiene.

I.R. Spectra

The I.R. spectra (FT-IR) were recorded by means of Thermo Nicolet Nexus 670 and Bruker IFS 48 spectrophotometers.

The I.R. spectra (FT-IR) of the polymers were obtained by polymer films on potassium bromide tablets (KBr), said film being obtained by deposition of a solution on the polymer to be analyzed in hot o-dichlorobenzene. The concentration of the polymer solutions analyzed was equal to 10% by weight with respect to the total weight of the polymeric solution.

Thermal Analysis (DSC)

DSC (Differential Scanning Calorimetry) thermal analysis, for the purpose of determining the melting point (Tₘ), the glass transition temperature (T_{g}) and the crystallization temperature (T_{c}) of the polymers obtained, was carried out by means of a differential scanning calorimeter DSC Q1000 by TA Instruments.

Molecular Weight Determination

Determination of the molecular weight (MW) and dispersion (Mw/Mn) of the polymers obtained was carried out with a Waters GPCV 2000 system, using two lines of detectors (differential viscometer and refractometer), operating under the following experimental conditions. The experimental conditions were:
two PLgel Mixed-C columns;
solvent/eluent: o-dichlorobenzene (Aldrich);
flow: 0.8 ml/min;
temperature: 145° C.;
molecular mass calculation: Universal Calibration method.

The weight average molecular weight (M_{w}) and the polydispersion index (PDI) corresponding to the ratio M_{w}/Mₙ(Mₙ=number average molecular weight) are reported.

Atomic Force Microscopy (MFA)

For this purpose, a thin film of stereoregular diblock polybutadiene to be analyzed was prepared, by depositing a solution in chloroform, or in toluene, of said stereoregular diblock polybutadiene by means of spin-coating on a silicon substrate.

The analysis was carried out without dynamic contact (non contact mode or tapping mode), using an NTEGRA Spectra atomic force microscope (AFM) of N-MDT. During scanning of the surface of said thin film, the variations in amplitude of the oscillations of the tip provide topographical information relating to the surface of the same (HEIGHT image). Moreover, the phase variations of the oscillations of the tip can be used to distinguish between different types of materials present on the surface of said film (different phases of the material).

By way of example, FIGS. 1a/1b/1c shows the AFM image of the butadiene/isoprene stereoblock copolymer obtained as described in Example 7. FIGS. 2a/2b/2c, for comparison, shows the AFM image of the mechanical mixture consisting of syndiotactic 1,2 polybutadiene/alternating cis-1,4/3,4 polyisoprene (40/60), and prepared as described below.

### Preparation of Syndiotactic 1,2 Polybutadiene/Alternating Cis-1,4/3,4 Polyisoprene Mechanical Mixture

2 grams of polyisoprene with a perfectly alternating cis-1,4/3,4 structure obtained as described in Example 3 and 1.04 grams of polybutadiene with a syndiotactic 1,2 structure obtained as described in Example 4 are introduced into a 250 ml flask and dissolved in toluene using heat. After being completely dissolved, the polymers are re-precipitated in a large excess of methanol, filtered and then dried under vacuum at room temperature for a whole night. The polymer thus obtained is used as is for AFM analysis.

### Example 1

### Preparation of the Catalyst or Precatalyst Component (1a-d)

0.13 grams of anhydrous CoCl₂ (1×10⁻³ moles) are dissolved in methylene chloride (30 ml) in a 100 ml flask; isopropyldiphenylphosphine (PⁱPrPh₂) (3×10⁻³ moles; 0.685 grams) is then introduced and kept under stirring at room temperature for around 3 hours. The blue solution thus obtained (1 ml≡1×10⁻⁴ moles of Co) (1a) is used in the amount indicated in the examples of co- and terpolymerization. The other catalytic components, or precatalyzers, which use different phosphines from PⁱPrPh₂ are prepared in exactly the same way. Therefore, in the case of the use of tert-butyldiphenylphosphine (P^{t}BuPh₂) (3×10⁻³ moles; 0.727 grams), cyclohexyldiphenylphosphine (PCyPh₂) (3×10⁻³ moles; 0.805 grams) and triphenylphosphine (PPh₃) (3×10⁻³ moles; 0.787 grams) the solutions (1b), (1c), and (1d) are obtained, respectively.

### Example 2

### Synthesis of Syndiotactic 1,2 Polypentadiene (Reference Homopolymer)

2 ml of (E)-1,3-pentadiene equal to 1.36 g was introduced into a 50 ml test-tube. 20 ml of heptane was subsequently added and the temperature of the solution thus obtained was taken to 25° C. Methylaluminoxane (MAO) in a toluene solution (1.89 ml; 3×10⁻³ moles, equal to about 0.174 g) was then added and, subsequently, the solution prepared as in example 1a (0.3 ml; 3×10⁻⁵ moles of Co), (molar ratio Al/Co=100). The whole mixture was kept under magnetic stirring at 25° C. for 90 minutes. The polymerization was then quenched by adding 2 ml of methanol. The polymer obtained was then coagulated by adding 40 ml of a methanol solution containing 4% of antioxidant Irganox© 1076 (Ciba) obtaining 1.36 g of polypentadiene, with a conversion equal to 100% and having a syndiotactic 1,2 structure. Further characteristics of the process and of the polypentadiene obtained are set down in Table 1.

FIG. 8 shows the FT-IR spectrum of the polypentadiene obtained.

FIG. 9 shows the ¹H and ¹³C NMR spectra.

### Example 3

### Synthesis of Alternating Cis-1,4/3,4 Polyisoprene (Reference Homopolymer)

5 ml di isoprene equal to 3.4 g was introduced into a 50 ml test-tube. 20 ml of heptane was subsequently added and the temperature of the solution thus obtained was taken to 25° C. Methylaluminoxane (MAO) in toluene solution (1.89 ml; 3×10⁻³ moles, equal to about 0.174 g) was then added and, subsequently, the solution prepared as in example 1a (0.3 ml; 3×10⁻⁵ moles of Co) (molar ratio Al/Co=100). The whole mixture was kept under magnetic stirring at 25° C. for 180 minutes. The polymerization was then quenched by adding 2 ml of methanol. The polymer obtained was then coagulated by adding 40 ml of a methanol solution containing 4% of antioxidant Irganox® 1076 (Ciba) obtaining 3.4 g di polyisoprene having a perfectly alternating cis-1,4/3,4 structure, with a conversion equal to 100%. Further characteristics of the process and of the polyisoprene obtained are set down in Table 1.

FIG. 10 shows the FT-IR spectrum of the polyisoprene obtained.

FIG. 11 shows the ¹H and ¹³C NMR spectra.

### Example 4

### Synthesis of Syndiotactic 1,2 Polybutadiene (Reference Homopolymer)

2 ml of 1,3-butadiene equal to about 1.4 g was condensed at a low temperature (−20° C.) in a 25 ml test-tube. 14.4 ml di toluene was subsequently added and the temperature of the solution thus obtained was taken to 25° C. Methylaluminoxane (MAO) in toluene solution (0.63 ml; 1×10⁻³ moles, equal to about 0.058 g) was then added and, subsequently, the solution prepared as in example 1a (0.1 ml; 1×10⁻⁵ moles of Co) (molar ratio Al/Co=100). The whole mixture was kept under magnetic stirring at 25° C. for 30 minutes. The polymerization was then quenched by adding 2 ml of methanol. The polymer obtained was then coagulated by adding 40 ml of a methanol solution containing 4% of antioxidant Irganox® 1076 (Ciba) obtaining 1.4 g of polybutadiene with a syndiotactic 1,2 structure, with a conversion equal to 100%. Further characteristics of the process and of the syndiotactic 1,2 polybutadiene obtained are set down in Table 1.

FIG. 12 shows the FT-IR spectrum of the syndiotactic 1,2 polybutadiene obtained.

FIG. 13 shows the ¹H and ¹³C NMR spectra of the syndiotactic 1,2 polybutadiene.

### Example 5

### Synthesis of Isoprene/Butadiene Stereoregular Copolymer with an Alternating 1,4-Cis/3,4 Structure for the Polyisoprene Block and a Syndiotactic 1,2 Structure for the Polybutadiene Block (Invention)

5 ml di isoprene equal to 3.4 g was introduced into a 50 ml test-tube. 20 ml of heptane was subsequently added and the temperature of the solution thus obtained was taken to 25° C. Methylaluminoxane (MAO) in toluene solution (1.89 ml; 3×10⁻³ moles, equal to about 0.174 g) was then added and, subsequently, the solution prepared as described in example 1d (0.3 ml; 3×10⁻⁵ moles of Co) (molar ratio Al/Co=100). The whole mixture was kept under magnetic stirring at 25° C. for 150 minutes and 0.5 ml of butadiene (0.35 g) dissolved in heptane (4.5 ml) was then added. The polymerization was left to proceed for a further 60 minutes and then quenched by adding 2 ml of methanol. The polymer obtained was then coagulated by adding 40 ml of a methanol solution containing 4% of antioxidant Irganox® 1076 (Ciba) obtaining 3.61 g of isoprene/butadiene copolymer, with a conversion equal to 97% relative to the total amount of charged monomers. Further characteristics of the process and of the isoprene-butadiene copolymer obtained are set down in Table 1.

FIG. 14 shows the FT-IR spectrum of the isoprene-butadiene stereoregular copolymer obtained.

FIG. 15 shows the ¹H and ¹³C NMR spectra.

FIG. 16 shows the DSC curve.

### Example 6

### Synthesis of Isoprene/Butadiene Stereoregular Copolymer with an Alternating 1,4-Cis/3,4 Structure for the Polyisoprene Block and a Syndiotactic 1,2 Structure for the Polybutadiene Block (Invention)

5 ml di isoprene equal to 3.4 g was introduced into a 50 ml test-tube. 20 ml of heptane was subsequently added and the temperature of the solution thus obtained was taken to 25° C. Methylaluminoxane (MAO) in toluene solution (1.89 ml; 3×10⁻³ moles, equal to about 0.174 g) was then added and, subsequently, the solution prepared as in example 1d (0.3 ml; 3×10⁻⁵ moles of Co) (molar ratio Al/Co=100). The whole mixture was kept under magnetic stirring at 25° C., for 150 minutes, then 1.5 ml of butadiene (1.05 g) dissolved in heptane (13.5 ml) was added. The polymerization was left to proceed for a further 60 minutes and then quenched by adding 2 ml of methanol. The polymer obtained was then coagulated by adding 40 ml of a methanol solution containing 4% of antioxidant Irganox® 1076 (Ciba) obtaining 4.36 g of isoprene/butadiene copolymer, with a conversion equal to 96.8% relative to the total amount of charged monomers. Further characteristics of the process and of the copolymer isoprene-butadiene obtained are set down in Table 1.

FIG. 17 shows the FT-IR spectrum of the isoprene-butadiene stereoregular copolymer obtained.

FIG. 18 shows the ¹H and ¹³C NMR spectra.

FIG. 19 shows the DSC curve.

### Example 7

### Synthesis of Isoprene/Butadiene Stereoregular Copolymer with an Alternating 1,4-Cis/3,4 Structure for the Polyisoprene Block and a Syndiotactic 1,2 Structure for the Polybutadiene Block (Invention)

5 ml of isoprene equal to 3.4 g was introduced into a 50 ml test-tube. 20 ml of heptane was subsequently added and the temperature of the solution thus obtained was taken to 25° C. Methylaluminoxane (MAO) in toluene solution (1.89 ml; 3×10⁻³ moles, equal to about 0.174 g) was then added and, subsequently, the solution prepared as in example 1c (0.3 ml; 3×10⁻⁵ moles of Co) (molar ratio Al/Co=100). The whole mixture was kept under magnetic stirring at 25° C., for 100 minutes, then 2.5 ml of butadiene (1.75 g) dissolved in heptane (22.5 ml) was added. The polymerization was left to proceed for a further 60 minutes and then quenched by adding 2 ml of methanol. The polymer obtained was then coagulated by adding 40 ml of a methanol solution containing 4% of antioxidant Irganox® 1076 (Ciba) obtaining 5.10 g of isoprene-butadiene copolymer, with a conversion equal to 99.1% relative to the total amount of charged monomers. Further characteristics of the process and of the copolymer isoprene-butadiene obtained are set down in Table 1.

FIG. 20 shows the FT-IR spectrum of the isoprene-butadiene stereoregular copolymer obtained.

FIG. 21 shows the ¹H and ¹³C NMR spectra.

FIG. 22 shows the DSC curve.

### Example 8

### Synthesis of Copolymer Butadiene/Isoprene Stereoregular with an Alternating 1,4-Cis/3,4 Structure for the Polyisoprene Block and a Syndiotactic 1,2 Structure for the Polybutadiene Block (Invention)

1.5 ml of butadiene equal to 1.05 g was condensed at a low temperature (−20° C.) in a 50 ml test-tube. 20.7 ml of heptane was subsequently added and the temperature of the solution thus obtained was taken to 25° C. Methylaluminoxane (MAO) in toluene solution (1.26 ml; 2×10⁻³ moles, equal to about 0.116 g) was then added and, subsequently, the solution prepared as in example 1a (0.2 ml; 2×10⁻⁵ moles of Co) (molar ratio Al/Co=100). The whole mixture was kept under magnetic stirring at 25° C. for 7 minutes, then 5 ml of isoprene (3.4 g) was added. The polymerization was left to proceed for a further 120 minutes and then quenched by adding 2 ml of methanol. The polymer obtained was then coagulated by adding 40 ml of a methanol solution containing 4% of antioxidant Irganox® 1076 (Ciba) obtaining 4.27 g of butadiene/isoprene copolymer, with a conversion equal to 95.1% relative to the total amount of charged monomers. Further characteristics of the process and of the butadiene/isoprene copolymer obtained are set down in Table 1.

FIG. 23 shows the FT-IR spectrum of the butadiene-isoprene stereoregular copolymer obtained.

FIG. 24 shows the ¹H and ¹³C NMR spectra.

### Example 9

### Synthesis of Butadiene/Isoprene Stereoregular Copolymer with an Alternating 1,4-Cis/3,4 Structure for the Polyisoprene Block and a Syndiotactic 1,2 Structure for the Polybutadiene Block (Invention)

2.0 ml of butadiene equal to 1.4 g was condensed at a low temperature (−20° C.) in a 50 ml test-tube. 25 ml of heptane was subsequently added and the temperature of the solution thus obtained was taken to 25° C. Methylaluminoxane (MAO) in toluene solution (1.26 ml; 2×10⁻³ moles, equal to about 0.116 g) was then added and, subsequently, the solution prepared as in example 1a (0.2 ml; 2×10⁻⁵ moles of Co) (molar ratio Al/Co=100). The whole mixture was kept under magnetic stirring at 25° C., for 18 minutes, then 8 ml of isoprene (5.44 g) was added. The polymerization was left to proceed for a further 360 minutes and then quenched by adding 2 ml of methanol. The polymer obtained was then coagulated by adding 40 ml of a methanol solution containing 4% of antioxidant Irganox© 1076 (Ciba) obtaining 6.6 g of butadiene/isoprene copolymer, with a conversion equal to 97.5% relative to the total amount of charged monomers. Further characteristics of the process and of the butadiene/isoprene copolymer obtained are set down in Table 1.

FIG. 25 shows the FT_IR spectrum of the copolymer butadiene isoprene diblock stereoregular obtained.

FIG. 26 shows the ¹H and ¹³C NMR.

### Example 10

### Synthesis of Butadiene/Isoprene Stereoregular Copolymer with an Alternating 1,4-Cis/3,4 Structure for the Polyisoprene Block and a Syndiotactic 1,2 Structure for the Polybutadiene Block (Invention)

1.0 ml of butadiene equal to 0.7 g was condensed at a low temperature (−30° C.) in a 50 ml test-tube. 25 ml of heptane was subsequently added and the temperature of the solution was taken to the temperature of 25° C. Methylaluminoxane (MAO) in toluene solution (1.26 ml; 2×10⁻³ moles, equal to about 0.116 g) was then added and, subsequently, the solution prepared as in example 1b (0.2 ml; 2×10⁻⁵ moles of Co) (molar ratio Al/Co=100). The whole mixture was kept under magnetic stirring at 25° C., for 15 minutes; 8 ml of isoprene (5.44 g) was then added. The polymerization was left to proceed for a further 300 minutes and then quenched by adding 2 ml of methanol. The polymer obtained was then coagulated by adding 40 ml of a methanol solution containing 4% of antioxidant Irganox® 1076 (Ciba) obtaining 5.9 g of butadiene/isoprene copolymer, with a conversion equal to 96.7% relative to the total amount of charged monomers. Further characteristics of the process and of the butadiene/isoprene copolymer obtained are set down in Table 1.

FIG. 27 shows the FT-IR spectrum of the butadiene-isoprene stereoregular copolymer obtained.

FIG. 28 shows the ¹H and ¹³C NMR spectra.

FIG. 29 shows the DSC curve.

### Example 11

### Synthesis of Butadiene/Isoprene Stereoregular Copolymer with an Alternating 1,4-Cis/3,4 Structure with Regard to the Polyisoprene Block and a Syndiotactic 1,2 Structure with Regard to the Polybutadiene Block (Invention)

4 ml of butadiene equal to 2.8 g was condensed at a low temperature (−30° C.) in a 50 ml test-tube. 25 ml of heptane was subsequently added and the temperature of the solution was taken to the temperature of 25° C. Methylaluminoxane (MAO) in toluene solution (0.63 ml; 1×10⁻³ moles, equal to about 0.058 g) was then added and, subsequently, the solution prepared as in example 1a (0.1 ml; 1×10⁻⁵ moles of Co) (molar ratio Al/Co=100). The whole mixture was kept under magnetic stirring for 200 minutes, then 5 ml of isoprene (3.4 g) was added. The polymerization was left to proceed for a further 300 minutes and then quenched by adding 2 ml of methanol. The polymer obtained was then coagulated by adding 40 ml of a methanol solution containing 4% of antioxidant Irganox© 1076 (Ciba) obtaining 6.0 g of butadiene/isoprene copolymer, with a conversion equal to 96.8% relative to the total amount of charged monomers. Further characteristics of the process and of the butadiene/isoprene stereoregular copolymer obtained are set down in Table 1.

FIG. 30 shows the FT-IR spectrum of the butadiene-isoprene stereoregular copolymer obtained.

FIG. 31 shows the ¹H and ¹³C NMR spectra.

### Example 12

### Synthesis of Isoprene/Pentadiene Stereoregular Copolymer with an Alternating 1,4-Cis/3,4 Structure for the Polyisoprene Block and a Syndiotactic 1,2 Structure for the Polypentadiene Block (Invention)

4 ml di isoprene equal to 2.72 g was introduced into a 50 ml test-tube. 20 ml of heptane was subsequently added and the temperature of the solution thus obtained was taken to 25° C. Methylaluminoxane (MAO) in toluene solution (1.89 ml; 3×10⁻³ moles, equal to about 0.174 g) was then added and, subsequently, the solution prepared as described in example 1a (0.3 ml; 3×10⁻⁵ moles of Co) (molar ratio Al/Co=100). The whole mixture was kept under magnetic stirring at 25° C. for 150 minutes, then 1 ml of E-1,3-pentadiene (0.68 g) dissolved in heptane (4 ml) was added. The polymerization was left to proceed for a further 120 minutes and then quenched by adding 2 ml of methanol. The polymer obtained was then coagulated by adding 40 ml of a methanol solution containing 4% of antioxidant Irganox® 1076 (Ciba) obtaining 3.33 g of isoprene/pentadiene copolymer, with a conversion equal to 97.9% relative to the total amount of charged monomers. Further characteristics of the process and of the isoprene/pentadiene copolymer obtained are set down in Table 1.

FIG. 32 shows the FT_IR spectrum of the isoprene/pentadiene stereoregular diblock copolymer obtained.

FIG. 33 shows the ¹H and ¹³C NMR spectra.

### Example 13

### Synthesis of Isoprene/Pentadiene Stereoregular Copolymer with an Alternating 1,4-Cis/3,4 Structure for the Polyisoprene Block and a Syndiotactic 1,2 Structure for the Polypentadiene Block (Invention)

3 ml di isoprene equal to 2.04 g was introduced into a 50 ml test-tube. 20 ml of heptane was subsequently added and the temperature of the solution thus obtained was taken to 25° C. Methylaluminoxane (MAO) in toluene solution (1.89 ml; 3×10⁻³ moles, equal to about 0.174 g) was then added and, subsequently, the solution prepared as described in example 1a (0.3 ml; 3×10⁻⁵ moles of Co) (molar ratio Al/Co=100). The whole mixture was kept under magnetic stirring at 25° C., for 150 minutes, then 2 ml of E-1,3-pentadiene (1.36 g) dissolved in heptane (2.5 ml) was added. The polymerization was left to proceed for a further 120 minutes and then quenched by adding 2 ml of methanol. The polymer obtained was then coagulated by adding 40 ml of a methanol solution containing 4% of antioxidant Irganox© 1076 (Ciba) obtaining 3.22 g of isoprene/pentadiene copolymer, with a conversion equal to 97.70% relative to the total amount of charged monomers. Further characteristics of the process and of the isoprene/pentadiene copolymer obtained are set down in Table 1.

FIG. 34 shows the FT_IR spectrum of the isoprene/pentadiene stereoregular copolymer obtained.

FIG. 35 shows the ¹H and ¹³C NMR spectra.

### Example 14

### Synthesis of Pentadiene/Isoprene/Butadiene Stereoregular Terpolymer with an Alternating 1,4-Cis/3,4 Structure for the Polyisoprene Block and a Syndiotactic 1,2 Structure for the Polypentadiene and Polybutadiene Blocks (Invention)

1 ml of E-1,3-pentadiene equal to 0.68 g was introduced into a 50 ml test-tube. 20 ml of heptane was subsequently added and the temperature of the solution thus obtained was taken to 25° C. Methylaluminoxane (MAO) in toluene solution (1.89 ml; 3×10⁻³ moles, equal to about 0.174 g) was then added and, subsequently, the solution prepared as described in example 1a (0.3 ml; 3×10⁻⁵ moles of Co) (molar ratio Al/Co=100). The whole mixture was kept under magnetic stirring at 25° C. for 120 minutes, then 3 ml of isoprene (2.04 g) dissolved in heptane (5 ml) was added. The polymerization was left to proceed for a further 150 minutes, then 1 ml of butadiene (0.7 g) dissolved in heptane (9 ml) was added and polymerization continued, still under stirring at room temperature, for a further 60 minutes. The polymerization was quenched by adding 2 ml of methanol. The polymer obtained was then coagulated by adding 40 ml of a methanol solution containing 4% of antioxidant Irganox® 1076 (Ciba) obtaining 3.34 g of pentadiene-isoprene-butadiene terpolymer, with a conversion equal to 98.5% relative to the total amount of charged monomers. Further characteristics of the process and of the pentadiene/isoprene/butadiene terpolymer obtained are set down in Table 1.

FIG. 36 shows the FT-IR spectrum of the pentadiene/isoprene/butadiene stereoregular terpolymer obtained.

FIG. 37 shows the ¹H and ¹³C NMR spectra.

### Example 15

### Synthesis of Pentadiene/Isoprene/Butadiene Stereoregular Terpolymer with an Alternating 1,4-Cis/3,4 Structure for the Polyisoprene Block and a Syndiotactic 1,2 Structure for the Polypentadiene and Polybutadiene Blocks (Invention)

0.5 ml of E-1,3-pentadiene equal to 0.34 g was introduced into a 50 ml test-tube. 20 ml of heptane was subsequently added and the temperature of the solution thus obtained was taken to 25° C. Methylaluminoxane (MAO) in toluene solution (1.89 ml; 3×10⁻³ moles, equal to about 0.174 g) was then added and, subsequently, the solution prepared as described in example 1a (0.3 ml; 3×10⁻⁵ moles of Co) (molar ratio Al/Co=100). The whole mixture was kept under magnetic stirring at 25° C., for 120 minutes, then 3 ml of isoprene (2.04 g) dissolved in heptane (5 ml) was added. The polymerization was left to proceed for a further 150 minutes, then 0.5 ml of butadiene (0.35 g) dissolved in heptane (9 ml) was added and polymerization continued, still under stirring and at room temperature, for a further 60 minutes. The polymerization was quenched by adding 2 ml of methanol. The polymer obtained was then coagulated by adding 40 ml of a methanol solution containing 4% of antioxidant Irganox© 1076 (Ciba) obtaining 2.69 g of pentadiene/isoprene/butadiene terpolymer, with a conversion equal to 95% relative to the total amount of charged monomers. Further characteristics of the process and of the pentadiene/isoprene/butadiene terpolymer obtained are set down in Table 1.

FIG. 38 shows the FT_IR spectrum of the pentadiene-isoprene-butadiene stereoregular terpolymer obtained.

FIG. 39 shows the ¹H and ¹³C NMR spectra.

### Example 16

### Synthesis of Butadiene/Isoprene/Butadiene Stereoregular Terpolymer with an Alternating 1,4-Cis/3,4 Structure for the Polyisoprene Block and a Syndiotactic 1,2 Structure for the Polybutadiene Blocks (Invention)

1.5 ml of butadiene equal to 1.05 g was condensed at a low temperature (−20° C.) in a 50 ml test-tube. 25 ml of heptane was subsequently added and the temperature of the solution thus obtained was taken to 25° C. Methylaluminoxane (MAO) in toluene solution (1.26 ml; 2×10⁻³ moles, equal to about 0.116 g) was then added and, subsequently, the solution prepared as in example 1c (0.2 ml; 2×10⁻⁵ moles of Co) (molar ratio Al/Co=100). The whole mixture was kept under magnetic stirring at 25° C. for 18 minutes, then 5 ml di isoprene (3.4 g) was added. The polymerization was left to proceed for a further 360 minutes, then 1 ml of butadiene (0.7 gr) in toluene solution (5 ml) was added, and the polymerization was left to proceed for a further 15 minutes. The polymerization was quenched by adding 2 ml of methanol. The polymer obtained was then coagulated by adding 40 ml of a methanol solution containing 4% of antioxidant Irganox© 1076 (Ciba) obtaining 4.89 g of butadiene/isoprene/butadiene terpolymer, with a conversion equal to 94.9% relative to the total amount of charged monomers. Further characteristics of the process and of the butadiene/isoprene/butadiene terpolymer obtained are set down in Table 1.

FIG. 40 shows the FT_IR spectrum of the butadiene/isoprene/butadiene stereoregular terpolymer obtained.

FIG. 41 shows the ¹H and ¹³C NMR spectra.

FIG. 42 shows the DSC curve.

### Example 17

### Synthesis of Butadiene/Isoprene/Butadiene Stereoregular Terpolymer with an Alternating 1,4-Cis/3,4 Structure for the Polyisoprene Block and a Syndiotactic 1,2 Structure for the Polybutadiene Blocks (Invention)

1.0 ml of butadiene equal to 0.7 g was condensed at a low temperature (−30° C.) in a 50 ml test-tube. 25 ml of heptane was subsequently added and the temperature of the solution was taken to the temperature of 25° C. Methylaluminoxane (MAO) in toluene solution (1.26 ml; 2×10⁻³ moles, equal to about 0.116 g) was then added and, subsequently, the solution prepared as in example 1b (0.2 ml; 2×10⁻⁵ moles of Co) (molar ratio Al/Co=100). The whole mixture was kept under magnetic stirring at 25° C., for 15 minutes; 8 ml of isoprene (5.44 g) was then added. The polymerization was left to proceed for a further 300 minutes, then a further 2 ml of butadiene (1.4 gr) was added and the polymerization was continued for a further 30 minutes. The polymerization was quenched by adding 2 ml of methanol. The polymer obtained was then coagulated by adding 40 ml of a methanol solution containing 4% of antioxidant Irganox© 1076 (Ciba) obtaining 7.18 g of butadiene/isoprene/butadiene terpolymer, with a conversion equal to 95.7% relative to the total amount of charged monomers. Further characteristics of the process and of the butadiene/isoprene/butadiene terpolymer obtained are set down in Table 1.

FIG. 43 shows the FT_IR spectrum of the butadiene/isoprene/butadiene stereoregular terpolymer obtained.

FIG. 44 shows the ¹H and ¹³C NMR spectra.

FIG. 45 shows the DSC curve.

### Example 18

0.5 grams of natural rubber and 1.5 grams of the isoprene/butadiene stereoregular copolymer according to Example 6 of the present invention are introduced into a 250 ml flask and dissolved in boiling toluene. Once the solubilization is complete, the polymers are re-precipitated in a large excess of methanol, filtered and then dried under vacuum at room temperature for a whole night up to constant weight. The polymer thus obtained is used as is for AFM analysis.

FIG. 47 shows the Atomic Force Microscopy (AFM) images of the above mixture.

Discussion of Differences of the Copolymers of the Invention from Copolymers of the Prior Art

Comparison between the isoprene/butadiene stereoregular copolymer according to Example 6 of the present invention and the butadiene-isoprene block copolymer according to Example 18 of US 2020/0109229 A1.

Both these two copolymers have a molar content of isoprene: butadiene of about 70:30. FIG. 46 (a) shows the ¹³C NMR spectrum (olefinic region) of the copolymer of Example 6 of the present invention, which is the same spectrum as that of FIG. 18b but with indication of the characteristic signals relating to the olefinic carbon atoms of 1,4-cis/3,4 polyisoprene (PI) and of syndiotactic 1,2 polybutadiene (PB).

FIG. 46 (b) shows the ¹³C NMR spectrum (olefinic region) of the copolymer of Example 18 of US 2020/0109229 A1, which is the same as the top spectrum of FIG. 26 of US 2020/0109229 A1, but with indication of the characteristic signals relating to the olefinic carbon atoms of 3,4 polyisoprene (PI) and syndiotactic 1,2 polybutadiene (PB).

As discussed in the section concerning the prior art, US 2020/0109229 A1 discloses copolymers obtained by iron catalysis in which the polybutadiene block consists of crystalline polybutadiene (the “hard block”) with an essentially 1,2 structure (1,2 content around 70-80%, the remaining units having a cis-1,4 structure), and in which the amorphous polyisoprene block is made up of polyisoprene (the “soft block”) with a predominantly 3,4 structure (around 70%, the remaining units having a cis-1,4 structure).

It is to be noted that while in the copolymer of US 2020/0109229 A1 the amorphous polyisoprene block has a predominantly 3,4 structure, in the copolymer of the present invention the amorphous polyisoprene block has a perfectly alternating cis-1,4-alt-3,4 structure.

The different structures of the polyisoprene blocks of US 2020/0109229 A1 and of the present invention appear evident from the comparison of the ¹³C NMR spectra of the olefinic regions of the two copolymers.

In the spectrum of FIG. 46 (b) the signals at 110 ppm and 145.33 ppm—corresponding to the C1 and C2 olefinic carbons of a 3,4 isoprene unit, respectively—are clearly indicative of 3,4 units involved in long 3,4 unit sequences, that is a polyisoprene block with a predominant 3,4 structure.

In the spectrum of FIG. 46 (a), the signals at 108.96 and 146.10 ppm again correspond to the C1 and C2 olefinic carbons of a 3,4isoprene unit, but involved in a perfectly alternating cis-1,4/3,4 structure. Such an alternating structure is confirmed by the presence of signals at 131.90 and 124.68 ppm, corresponding to the C2 and C3 olefinic carbons of a cis-1,4 isoprene unit involved in perfectly alternating cis-1,4-alt-3,4 isoprene unit sequences.

The features discussed above show the structural differences between the copolymers of the prior art, obtained by catalytic systems based on iron compounds, and the copolymers of the invention, obtained by catalytic systems based on cobalt compounds.

One of the effects of the structural differences discussed above is that the block copolymers of the invention show a good compatibility with natural rubber, as shown by the AFM images of FIG. 47, likely due to the high content of isoprene units with a cis-1,4 structure.

TABLE 1
Copolymerization of dienes with CoCl₂/Phosphine/MAO ^{a)}

| | Polymerization | | | | | | | | | Composition | | | Characterization polymer | | | | | | |
|---|---|---|---|---|---|---|---|---|---|---|---|---|---|---|---|---|---|---|---|
| | Conc | | Pentadiene | Isoprene | Butadiene | | Time | Yield | Conv. | polymer (molar %) | | | (rr)^{(b)} | (rr)^{(c)} | Tₘ^{(d)} | T_{c}^{(e)} | T_{g}^{(f)} | M_{w} | M_{w}/ |
| Example | (μmol) | Phosphine | (ml) | (mL) | (mL) | Feed P/I/B | (min) | (g) | (%) | Pentadiene | Isoprene | Butadiene | (%) | (%) | (° C.) | (° C.) | (° C.) | (g/mol) | Mₙ |
| 2 | 30 | iso-propyl- | 2 | — | — | 100/0/0 | 90 | 1.36 | 100 | 100 | — | — | | 90 | 132 | | | 180000 | 2.3 |
| | | diphenylphosphine | | | | | | | | | | | | | | | | | |
| 3 | 30 | iso-propyl- | — | 5 | — | 0/100/0 | 180 | 3.4 | 100 | — | 100 | — | | | | | −18 | 89100 | 2.3 |
| | | diphenylphosphine | | | | | | | | | | | | | | | | | |
| 4 | 10 | iso-propyl- | — | — | 2 | 0/0/100 | 105 | 1.4 | 100 | — | — | 100 | 80.5 | | 125 | | | 240000 | 1.8 |
| | | diphenylphosphine | | | | | | | | | | | | | | | | | |
| 5 | 30 | tri- | — | 5 | 0.5 | 0/88.5/11.5 | 150 + 60 | 3.61 | 97 | — | 84.6 | 15.4 | 62.5 | | 79.8 | 36.2 | −19 | 198000 | 2.1 |
| | | phenylphosphine | | | | | | | | | | | | | | | | | |
| 6 | 30 | tri- | — | 5 | 1.5 | 0/72.1/27.9 | 150 + 60 | 4.36 | 96.8 | — | 71.4 | 28.6 | 66.0 | | 80.3 | 39.5 | −18 | 211300 | 2.0 |
| | | phenylphosphine | | | | | | | | | | | | | | | | | |
| 7 | 30 | Cyclohexyl- | — | 5 | 2.5 | 0/61.0/39.0 | 150 + 60 | 5.10 | 99.1 | — | 59.6 | 40.4 | 70.0 | | 106.5 | 56.3 | −18 | 291500 | 2.3 |
| | | diphenylphosphine | | | | | | | | | | | | | | | | | |
| 8 | 20 | iso-propyl- | — | 5 | 1.5 | 0/72.1/29.9 | 7 + 120 | 4.27 | 95.1 | — | 69.3 | 30.7 | 76.4 | | 123.6 | 99.8 | −19 | 288000 | 1.8 |
| | | diphenylphosphine | | | | | | | | | | | | | | | | | |
| 9 | 20 | iso-propyl- | — | 8 | 2.0 | 0/75.5/24.5 | 18 + 360 | 6.6 | 97.5 | — | 76.1 | 23.9 | 74.4 | | 128.3 | 103.7 | −18 | 307200 | 2.2 |
| | | diphenylphosphine | | | | | | | | | | | | | | | | | |
| 10 | 20 | tert-butyl | — | 8 | 1.0 | 0/86/14 | 45 + 300 | 5.9 | 96.7 | — | 83.5 | 16.5 | 82.5 | | 122.7 | 99.3 | −17 | 211100 | 1.9 |
| | | diphenylphosphine | | | | | | | | | | | | | | | | | |
| 11 | 10 | iso-propyl- | — | 5 | 4.0 | 0/50.9/49.1 | 200 + 300 | 6.0 | 96.8 | — | 50 | 50 | 73.7 | | 110.5 | 77.7 | −18 | 315200 | 1.7 |
| | | diphenylphosphine | | | | | | | | | | | | | | | | | |
| 12 | 30 | iso-propyl- | 1 | 4 | — | 20/80/0 | 150 + 120 | 3.33 | 97.9 | 18.5 | 81.5 | — | | 84.7 | 119.0 | | −19 | 220000 | 2.1 |
| | | diphenylphosphine | | | | | | | | | | | | | | | | | |
| 13 | 30 | iso-propyl- | 2 | 3 | — | 40/60/0 | 150 + 120 | 3.22 | 97.7 | 39.1 | 60.9 | — | | 87.8 | 124.6 | | −18 | 21200 | 2.2 |
| | | diphenylphosphine | | | | | | | | | | | | | | | | | |
| 14 | 30 | iso-propyl- | 1 | 3 | 1 | 18.9/56.6/24.5 | 120 + 150 + 60 | 3.34 | 98.5 | 19.2 | 57 | 23.8 | 78.5 | 85.0 | ~120 | | −19 | 306000 | 2.3 |
| | | diphenylphosphine | | | | | | | | | | | | | | | | | |
| 15 | 30 | iso-propyl- | 0.5 | 3 | 0.5 | 12/72.3/15.7 | 120 + 150 + 60 | 2.69 | 95 | 12.5 | 72.6 | 14.9 | 75.1 | 83.8 | ~118 | | −18 | 292500 | 2.2 |
| | | diphenylphosphine | | | | | | | | | | | | | | | | | |
| 16 | 20 | Cyclohexyl- | — | 5 | 2.5 | 0/61/39 | 18 + 360 + 15 | 4.89 | 94.9 | — | 61.4 | 38.7 | 68.6 | | 105.5 | 57.9 | −18 | 245000 | 2.3 |
| | | diphenylphosphine | | | | | | | | | | | | | | | | | |
| 17 | 20 | tert-butyl | — | 8 | 3 | 0/67.3/32.7 | 45 + 300 + 30 | 7.18 | 95.7 | — | 71 | 29 | 81.0 | | | 119.5 | −18 | 236300 | 2.2 |
| | | diphenylphosphine | | | | | | | | | | | | | | | | | |

(a): polymerization conditions: in examples 5-7 first isoprene and then butadiene were added; in examples 8-11, first butadiene and then isoprene; in examples 12,13 first pentadiene and then isoprene; in examples 14,15 first pentadiene, then isoprene and, finally, butadiene; in examples 16,17 first butadiene, then isoprene and, finally, butadiene again; polymerization temperature 25° C.
(b): content of syndiotactic triads [(rr) %] in the polybutadiene block with a syndiotactic 1,2 structure determined by means of ¹³C-NMR analysis;
(c): content of syndiotactic triads [(rr) %] in the polypentadiene block with a syndiotactic 1,2 structure determined by means of ¹³C-NMR melting point analysis;
(d): melting point;
(e): crystallization temperature;
(f): glass transition temperature.

1-22. (canceled)

23. A composition of stereoblock copolymers having a general formula (I) 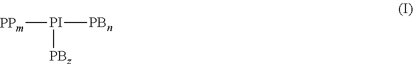
wherein:
PI is a 1,4-cis/3,4 polyisoprene block with an alternating structure;
PB is a polybutadiene block with a syndiotactic 1,2 structure in which the content in 1,2 units is ≥80%;
PP is a polypentadiene block with a syndiotactic 1,2 structure in which the content in 1,2 units is ≥90%;
m, n, and z are equal to 1 or equal to 0 according to the following conditions:
m and n are simultaneously equal to 1 or alternatively m is equal to 1 and n is equal to zero, or m is equal to 0 and n is equal to 1;
if m is equal to 1, z is equal to 0 and n is equal to 1 or 0;
if m is equal to 0, n is equal to 1, and z is equal to 1 or equal to 0.

24. The stereoblock copolymers according to claim 23, wherein m is equal to 0 and n is equal to 1 and z is equal to 0, having general formula (II):
PI-PB (II)

25. The stereoblock copolymers according to claim 23, wherein m is equal to 1 and n and z are equal to 0, having general formula (III):
PI-PP (III)

26. The stereoblock copolymers according to claim 23, in which m is equal to 1 and n is equal to 1 and z is equal to 0, having general formula (IV):
PP-PI-PB (IV)

27. The stereoblock copolymers according to claim 23, wherein m is equal to 0, n is equal to 1 and z is equal to 1, having general formula (V):
PB-PI-PB (V)

28. The stereoblock copolymers according to claim 23, wherein the polyisoprene block is present in a molar amount of from 10% to 90%.

29. The stereoblock copolymers according to claim 23, comprising a polydispersity index from 1.5 to 2.3.

30. The stereoblock copolymers according to claim 23, wherein the polyisoprene block has a glass transition temperature from −10° C. to −30° C.

31. The stereoblock copolymers according to claim 23, wherein the polyisoprene block is amorphous from 20° C. to 25° C.

32. The stereoblock copolymers according to claim 23, wherein the polybutadiene block has a glass transition temperature from −10° C. to −24° C.

33. The stereoblock copolymers according to claim 23, wherein the polybutadiene block has a melting point from 70° C. to 140° C.

34. The stereoblock copolymers according to claim 23, wherein the polybutadiene block has a crystallization temperature from 55° C. to 130° C.

35. The stereoblock copolymers according to claim 23, wherein the polybutadiene block has a content of syndiotactic triads from 15% to 90%.

36. The stereoblock copolymers according to claim 23, wherein the polypentadiene block has a glass transition temperature from −12° C. to −25° C.

37. The stereoblock copolymers according to claim 23, wherein the polypentadiene block has a melting point from 80° C. to 160° C.

38. The stereoblock copolymers according to claim 23, wherein the polypentadiene block has a crystallization temperature from 60° C. to 135° C.

39. The stereoblock copolymers according to claim 23, wherein the polypentadiene block has a content of syndiotactic triads comprised from 15% to 90%.

40. A process for preparation of the stereoblock copolymer composition according to claim 23, comprising:
a) subjecting to total stereospecific polymerization a first monomer selected from isoprene, pentadiene or butadiene in the presence of a catalytic system obtained from cobalt dichloride, a phosphine of general formula (VI)
Rₘ—P-Phₙ (VI)
wherein m=0, 1, 2 and n=1, 2, 3, and wherein:
P is trivalent phosphorus;
R is selected from linear or branched C₁-C₂₀ alkyl or C₃-C₃₀ cycloalkyl;
Ph is a phenyl group of formula (VII) 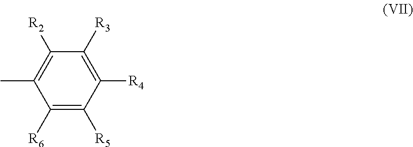
wherein R₂, R₃, R₄ and R₅ are independently selected from the group consisting of H and C₁-C₆ alkyl,
and a co-catalyst selected from the aluminum compounds of general formula (VIII) or of general formula (IX), wherein general formula (VIII) is
Al(X′)ₙ(R₆)₃₋ₙ (VIII)
wherein n=0, 1, 2 and
wherein X′ represents a halogen atom selected from the group consisting of chlorine, bromine, iodine, and fluorine, and
wherein R₆ is selected from the group consisting of linear or branched C₁-C₂₀ alkyl, cycloalkyl, and aryl, all optionally substituted with one or more silicon or germanium atoms;
wherein general formula (IX) is
(R₇)₂—Al—O—[—Al(R₈)—O-]ₚ-Al—(R₉)₂ (IX)
wherein p is an integer from 0 to 1000 and wherein
R₇, R₈ and R₉, are independently selected from the group consisting of hydrogen, chlorine, bromine, iodine, fluorine, linear or branched C₁-C₂₀ alkyl optionally substituted with one or more silicon or germanium atoms, cycloalkyl optionally substituted with one or more silicon or germanium atoms, and aryl optionally substituted with one or more silicon or germanium atoms;
so as to obtain a first stereoblock consisting of units of said first monomer;
b) in the presence of the first stereoblock, subjecting to total stereospecific polymerization a second monomer different from the first monomer, the second monomer selected from isoprene, pentadiene or butadiene, provided that if the first monomer consists of butadiene or pentadiene, the second monomer consists of isoprene, so as to obtain a second stereoblock consisting solely of units of said second monomer, wherein the second stereoblock is joined to the first stereoblock in a single junction point.

41. The process according to claim 40, further comprising:
c) in the presence of the first and second stereoblocks in which the second stereoblock consists of isoprene, subjecting a third monomer selected from pentadiene or butadiene to total stereospecific polymerization so as to obtain a third stereoblock consisting solely of units of said third monomer, wherein the third stereoblock is joined to the second stereoblock in a single junction point;
with the exclusion of pentadiene as a third stereoblock when the first stereoblock consists of pentadiene units;
wherein in steps b) and c) the polymerization is carried out in the presence of the same catalytic system of step a).

42. The process according to claim 40, carried out in the presence of an inert organic solvent selected from the group consisting of: saturated aliphatic hydrocarbons and mixtures thereof; saturated cycloaliphatic hydrocarbons and mixtures thereof; mono-olefins and mixtures thereof; aromatic hydrocarbons and mixtures thereof; halogenated hydrocarbons and mixtures thereof.
